(19) United States
(12) Patent Application Publication
(10) Pub. No.: US 2024/0165628 A1
(43) Pub. Date: May 23, 2024

(54) AN APPARATUS AND ASSOCIATED METHODS FOR THERMAL CYCLING

(71) Applicant: BG Research Ltd, Kimbolton (GB)

(72) Inventor: Nelson Nazareth, Upper Dean (GB)

(21) Appl. No.: 18/551,025

(22) PCT Filed: Mar. 18, 2022
(86) PCT No.: PCT/GB2022/050686

§ 371 Date: Sep. 18, 2023

(30) Foreign Application Priority Data
Mar. 19, 2021 (GB) 2103831.0
Dec. 22, 2021 (GB) 2118743.0

(51) Int. Cl. B01L 7/00; B01L 7/04

(52) U.S. Cl. CPC B01L 7/52; B01L 7/04; B01L 2200/147; B01L 2300/023; B01L 2300/041; B01L 2300/0809; B01L 2300/12; B01L 2300/1822

(57) ABSTRACT

An apparatus comprising:
first and second Peltier devices arranged in substantial opposition to one another; and
a thermally conducting chamber defined substantially between the first and second Peltier devices and configured to enclose a reaction vessel during use to facilitate a transfer of heat between the reaction vessel and the Peltier devices.

### TECHNICAL FIELD

Field pathogen detection direct from crude samples using molecular approaches reliant upon thermal cycling and fluorescent detection, such as RT-QPCR.

### BACKGROUND

The first problem to be addressed is the rapid and uniform thermal cycling of large volume reactions to perform the direct RT-qPCR process in the shortest possible period of time. It is of considerable commercial advantage, as demonstrated by the COVID-19 pandemic, to be able to perform detection while the patient waits and at the point of need, and further advantage would be gained from being able to perform such testing at any location without infrastructure (for example without access to grid electrical power) or being limited in operation to expert molecular biologists.

It is known that more rapid thermal cycling offers performance benefits because there is less time to make spurious products or incur additional time in the presence of any inhibitory compounds when crude samples are added directly into the reaction, as directed by this application (Carl Wittwer; Rapid thermal cycling and PCR kinetics. PCR Applications, Page: 211-229; 1999). In Co-Pending application GB2019052133, the inventors outline a process for direct detection of viral pathogens from crude biological samples. A key aspect of this specification is the use of multiple rounds of reverse transcription to maximise the chances of pathogen detection at low viral titres. It is known that Viral RNA is labile in buffers commonly used in molecular biology and particularly in the presence of divalent cations required for the activity of polymerase enzymes and as a result more rapid thermal cycling has an additive benefit to the direct pathogen detection chemistry (Barshevskaia T N, Goriunova L E, Bibilashvili R S h. Non-specific RNA degradation in the presence of magnesium ions]. Mol Biol (Mosk). 1987 September-October; 21(5):1235-41). More rapid thermal cycling benefits the PCR but also ensures that more viral RNA target remains intact and as such increases the utility of the cyclical reverse transcription process. Most standard reactions are centred on volumes of 25 ul.

In the present application the focus is on larger reaction volumes, necessitated by a requirement to add the sample without any prior pre-processing steps.

In a conventional block thermal cycler the block holding the tubes is heated and cooled by Peltier(s) placed below a block of metal into which receptacles for reaction vessels have been created.

In this specification the terms TEC, Peltier and thermoelectric cooler are used interchangeably. Similarly the terms reaction vessel, vessel and tube are taken to mean the receptacle in which the PCR reaction takes place.

In some conventional thermal cyclers, additional heating means are provided to ensure uniformity of temperature across the block, but the TEC devices remain in intimate contact with the block and hence are effectively thermal cycling the block, as opposed to directly heating/cooling the vessel itself or indeed its contents. This introduces a significant amount of thermal lag in the system, as thermal transfer is from the Peltier device to the metal block holding the vessel, then to the vessel and ultimately to the liquid contents of the vessel themselves.

Additionally, low surface area to volume is a feature of the vessels conventionally used in the PCR process, making for slower thermal equilibration of the vessel contents. This is further compounded by the fact that the vessels are formed from polypropylene, which is an effective insulator and hence is not suited to the rapid thermal transitions required by this process.

Such block thermal cyclers are exemplified by prior art such as that disclosed in US2005145273A1, EP2060324A1 described by Applied Biosystems and Roche and comprise an array of Peltier devices with a single heatsink shared between the devices and a metal block attached to the working face into which the sample receptacles have been machined, this is typically in a 96 well SBS microplate format.

Alternate approaches have been described to increase the speed and uniformity of thermal cycling. These include air thermal cyclers as disclosed in EP1674585A1 and EP2227559A1 by the University of Utah and Corbett research, but the volumes and requirement for glass capillaries (University of Utah) render them unsuitable to this process.

Further alternatives have been described that achieve the thermal ramping rates by the use of reducing reaction volumes to the nanolitre or single digit microlitre ranges, similar to that disclosed in US2014080133A1. These generally rely on thin film heaters or printed circuit devices and the heating of small droplet sized reactions. For that reason these would be entirely unsuited to a direct RT-qPCR approach where volumes of crude sample would minimally be 5 ul in order to get enough of the target material into the reaction and they have no means to be sealed in a biosecure fashion as they are typically sealed by the use of adhesive film.

Approaches reliant on shuttling the reaction contents between static thermal zones have also been described such as in EP1885885A2. These approaches rely on the use of very small reactions and have moving parts, or microfluidics and actuators and for this would not be applicable to the processing of large volume direct RT-qPCR reactions requiring the biosecure handling of large volumes of crude samples.

Alpha Helix have described an alternate approach based on increasing the rate of thermal homogenisation by the use of centrifugal force as disclosed in EP1173284A1. However, such an approach requires the use of a large instrument, capable of centrifugation and as such is entirely unsuited to in-field portable use.

Lastly, approaches have been described using direct radiation, either from a lamp or microwaves (US27828606A) and the use of blown ambient air as the cooling system. These suffer similar issues with regards to reaction volume, non-standard reaction vessels and ambient air would be too slow for a larger reaction volume to cool rapidly.

In summary, alternate approaches either rely on small volumes or having vessels made from materials such as glass, which are unsuited to handling of samples potentially containing highly pathogenic organisms. The direct pathogen methodology described here and in co-pending applications necessitates a requirement for larger reaction volumes as crude samples must be added at maximally 20% of final reaction volume and as such typical reaction volumes may be in the range of 10 ul of crude sample in a 60 ul total reaction volume, or to 20 ul of crude sample in a 120 ul reaction volume.

The technical solution to these limitations is to remove the requirement for the sample holder or “block” and use a pair of opposing Peltier cells to directly hold the entire reaction vessel and create a thermally enclosed chamber in which substantially all of the reaction vessel is in direct contact with the Peltier and the Thermal Conductive Chamber (TCC) surfaces. This removes a number of thermal junctions and the mass of the sample holder itself, such that heat is directly pumped into and out of the reaction vessels. This is combined with the use of reaction vessels formed from thermally conductive materials and having increased surface area to volume ratio, ensuring rapid thermal cycling and equilibration of the vessel contents.

In a conventional thermal cycler a section of the reaction vessel may always be exposed above the surface of the heated portion. Enclosing substantially all of the reaction vessel inside the cycling portion ensures that the whole reaction volume (liquid) will cycle uniformly under the rapid cycling conditions and remove the need for a heated lid above the reaction vessel to prevent condensation. This implementation will be termed the Thermal Conducting Chamber (TCC) to indicate an enclosed direct conduction chamber concept where the whole reaction vessel sits substantially inside the temperature-controlled chamber and the vessel contents are therefore able to rapidly come to homogenous temperatures as required by the process.

In some embodiments, the apparatus described herein also comprises a cap portion, for example a dual-purpose cap portion. The dual-purpose cap portion typically comprises a central peltier and is able to both a) heat to a sufficient temperature so as to weld the lid of the vessel to the body of the vessel (and concomitantly remove any additional superfluous lid material to allow the vessel and lid to sit wholly within the TCC); and b) cycle between an appropriate range of temperatures, in line with the reaction conditions for the particular assay, so that the formation of condensation at the top of the vessel is prevented as the vessel and lid are largely at the same temperature, whilst maintaining as energy efficient process as possible, which is considered to be important when the thermal cycling devices are powered by battery, for example. Details of the dual-purpose cap portion are described elsewhere herein.

The second aspect is the reaction vessel itself. BG Research Ltd has previously described reaction vessels with major and minor walls, the minor walls being ‘optically clear’ and the major walls being formed of carbon loaded polymer (WO2017055791). The vessel system, defined as the reaction vessel and co-joined lid, is manufactured as a single part by a two-shot injection moulding process. A similar vessel was originally described by Cepheid for use in their Smartcycler™ system (U.S. Pat. No. 5,958,349), though in that instance the vessel is formed of an injection moulded frame to which plastic film is attached to make the reaction chamber.

The proposed vessel is different in that it is constructed from a two-shot injection moulded process with high thermal conductivity walls, with a welded lid to ensure biosecurity. The Cepheid system only has one of the major walls in contact with the thermally cycled holder.

The advantage is achieved from the greater surface area to volume ratio (FIG. 11). This filing will describe an improvement to such reaction vessels (the BGR and Cepheid filings (shown in the prior art section below)), where the sealing means is improved through the use of a welded lid and that the portion designed to be welded is formed as a single piece or part with the vessel itself (FIG. 2.4). The Cepheid vessel uses a fir tree push in lid to seal the vessel and then heats a single major wall of the vessel by a piggybacked TEC (one controls the back face temperature of the other). The background BGR IP uses a TEC on either side of the reaction vessel but that has a sample holder in direct opposition to the stated improvements described in this application, in that removing the requirement for a sample holder can greatly improve thermal cycling rates and uniformity. Therefore, in both cases the screw down lid of the prior BG Research IP or the fir tree cap of the Cepheid vessel would not be able to be placed in their entirety into an isothermal chamber because the securing means, or lids, for preventing egress of the reactants are bigger than the width available of a sample holder that would be contiguous with the heated portion of any vessel. This creates cooler spots in the vessel due to the unheated surface and slow the thermal cycling rates and importantly, the equilibration times.

Any vessel structures outside of the thermal chamber will cycle thermally at a differing rate and will affect the temperature of the vessel contents through losses attributable to radiation and convection and conduction. The parts of the vessel outside the vessel holder are known to take heat from the Peltiers (TECs) and are also able to thermal cycle, albeit at a lower rate as the lid is not as thermally conductive as the carbon-loaded vessel. This has the effect of reducing the rate of thermal cycling of the vessel contents or creating a temperature gradient within the liquid contents leading to increased time to result or reduced sensitivity due to the compounding effects of RNA denaturation and poorer PCR performance. This could partially be overcome by providing a greater input of power to the heaters, which would reduce battery life and therefore number of tests in a portable, battery powered device.

Welding the vessel shut therefore has the dual benefits of allowing a lid to be formed at the top of the reaction chamber that is capable of being the same exterior dimensions as the top of the vessel and being completely biosecure (FIGS. 4.1 and 4.3). Having a seal with the same exterior dimensions as the top of vessel enables the whole vessel to be lowered into the TCC (FIG. 4.3). The proposed form of the lid would allow the whole vessel to be substantially within the chamber. The welded surface makes the vessel biosecure, forming a permanent seal which has not been described previously in a PCR thermal cycling vessel context.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

According to a first aspect, there is provided an apparatus comprising:
first and second Peltier devices arranged in substantial opposition to one another; and
a thermally conducting chamber defined substantially between the first and second Peltier devices and configured to enclose a reaction vessel during use to facilitate a transfer of heat between the reaction vessel and the Peltier devices.

The thermally conducting chamber may be configured to physically contact all, or substantially all, of the external surface area of the reaction vessel during use.

The reaction vessel may comprise one or more window portions for optical interrogation of its contents, and the thermally conducting chamber may be configured to physically contact substantially all of the external surface area of the reaction vessel during use, except for the one or more window portions, or a portion of one or more windows, for example a portion of the window near the top of the vessel.

The thermally conducting chamber may comprise two or more discrete portions configured to physically contact one another to enclose the reaction vessel.

The thermally conducting chamber may be at least partially formed from a first face of one or both Peltier devices. The thermally conducting chamber may be at least partially formed from a first face of both Peltier devices. In some preferred embodiments, the thermally conducting chamber is entirely, or substantially entirely formed from the first face of both peltier devices. The third peltier face at the top of the lid may complete the thermally conducting chamber during the thermal cycling process

The first face of each Peltier device may be formed from one or more of a ceramic, a metal, an alloy, aluminium, copper, aluminium oxide and aluminium nitride.

The thermally conducting chamber may comprise a frame of thermally conducting material attached to a first face of one or both Peltier devices.

The first face of one or both Peltier devices may comprise a metal coating to facilitate attachment (e.g. by soldering) of the frame thereto.

The metal coating may comprise nickel.

The thermally conducting chamber may comprise a removable frame of thermally conducting material configured to be placed in contact with a first face of each Peltier device during use.

The frame may be formed from one or more of a ceramic, a metal, an alloy, copper and aluminium (or similar thermally conducting material).

The reaction vessel may have a generally rectangular cross-section defined by two major walls and two minor walls, and the thermally conducting chamber may be configured such that each Peltier device is adjacent to a respective major wall of the reaction vessel during use.

The reaction vessel may have a lid, and the thermally conducting chamber may be configured such that the lid of the reaction vessel is positioned between the Peltier devices during use.

The reaction vessel may have a flanged lid, and the thermally conducting chamber may be configured such that the flanged lid protrudes from between the Peltier devices during use. This arrangement may assist in handling/removal of the reaction vessel.

The thermally conducting chamber may have a substantially symmetric configuration.

The reaction vessel may have a non-flanged lid, and the thermally conducting chamber may have a substantially symmetric or asymmetric configuration.

The thermally conducting chamber may comprise a cap portion configured to physically contact the lid of the reaction vessel during use.

The cap portion may comprise a heating element configured to enable the lid of the reaction vessel to be heated independently of heating by the first and second Peltier devices that define the thermally conducting chamber.

As described above, the cap portion can have at least two uses, i.e. in some embodiments the cap portion is a dual-purpose cap portion. The first purpose of the dual-purpose cap portion may be to function in combination with the first and second peltier to form a third wall of the TCC and to ensure rapid and appropriate heating/cooling of the vessel in the TCC. In some embodiments the cap portion comprises a third peltier, and in some further embodiments a first face of the third peltier directly contacts the lid portion of the vessel once it is in situ in the TCC. The cap portion of the present invention is, in preferred embodiments, capable of thermal cycling, and can be set to follow a similar or the same cycling programme as the first and second Peltiers that define the thermally conducting chamber. The skilled person will appreciate that, in some embodiments, the thermal cycling programme of the cap portion ought to be off-set slightly from the thermal cycling programme of the first and second Peltier devices that define the thermally conducting chamber, i.e. the cap portion ought to reach the necessary temperature some seconds or milliseconds prior to the thermally conducting chamber reaching the same temperature.

A second purpose that the dual-purpose cap portion may have is the ability to both weld the lid to the vessel, i.e. the ability to heat to a sufficiently high temperature for a sufficiently long period of time so as to melt the material of the vessel and/or lid such that the two are completely sealed. In performing the welding action, the cap portion may also have the ability to remove any additional superfluous lid material to allow the vessel and lid to sit wholly within the TCC. For example, in some embodiments the lid may comprise material other than the material that ultimately forms the sealed lid, for example may comprise a flanged portion. In some embodiments the cap portion pressure welds the lid into the vessel, and any material from the lid that overhangs the external face of the vessel is removed. In some embodiments the cap portion punches the lid into the vessel, and any material from the lid that overhangs the external face of the vessel is removed.

The cap portion may comprise a Peltier device (termed the third Peltier device).

The heating element may be configured to heat the lid of the reaction vessel up to 100, 150, 200, 250 or 300° C.

The cap portion may comprise a temperature sensor.

Each Peltier device may have a first face and a second face, and the first face and second face of each Peltier device may comprise one or more respective temperature sensors.

The apparatus may comprise a controller configured to receive measurements from the temperature sensors and control the temperature of one or more of the first Peltier device, the second Peltier device and the cap portion (for example and the third Peltier present in the cap portion) of the thermally conducting chamber based on the received measurements (e.g. in relation to the required set-point). The temperature of the first Peltier device, second Peltier device and/or cap portion (for example and/or third Peltier present in the cap portion) may be independently controlled.

The controller may be configured to apply a common temperature cycle to the Peltier devices and cap portion. For example in some embodiments the controller is configured to apply a common temperature cycle to the first Peltier and the second Peltier, and to apply the common temperature cycle to the third Peltier, but at a slightly advanced time point.

The controller may be configured to apply a temporal offset such that the temperature cycle of the cap portion (for example of the third Peltier) is advanced relative to the temperature cycle of the first and second Peltier devices.

The second face of each Peltier device may comprise a heat sink having a fan, and the controller may be configured to control the speed of the fans based on the received measurements from the temperature sensors on the first and/or second faces of the Peltier devices.

The cap portion may comprise a ceramic and a metal plate configured to facilitate the transfer of heat between the ceramic and the lid of the reaction vessel.

The ceramic may comprise aluminium oxide or aluminium nitride and the metal plate may comprise aluminium or copper.

The cap portion may comprise a metal and the heating element may comprise a wire heater formed within the metal.

The metal may comprise aluminium or copper and the wire heater may be formed from nichrome.

The cap portion may comprise a non-stick coating configured to prevent adhesion of the lid of the reaction vessel to the cap portion.

The non-stick coating may comprise one or more of polytetrafluoroethylene and xylan (or similar as known in the art).

The cap portion may be hingedly or detachably coupled to another portion of the thermally conducting chamber.

The reaction vessel may have a flanged lid comprising a flange portion, and the cap portion of the thermally conducting chamber may comprise cutting means for removing the flange portion of the flanged lid.

The thermally conducting chamber may be configured such that the cap portion applies pressure to the lid of the reaction vessel during use.

The thermally conducting chamber may comprise a base portion, and the apparatus may comprise an ejection system formed in the base portion for ejecting the reaction vessel from the thermally conducting chamber after use.

The ejection system may comprise a temperature sensor and may be configured to automatically stop heating of the reaction vessel when a temperature measured by the temperature sensor exceeds a predefined threshold.

The ejection system may comprise a biasing means configured to force the reaction vessel towards the cap portion of the thermally conducting chamber during use.

The cap portion may be configured to be opened to enable removal of the reaction vessel from the thermally conducting chamber, and the ejection system may be coupled to the cap portion such that the reaction vessel is raised from the base portion as the cap portion is opened.

The apparatus may comprise biasing means configured to force the Peltier devices together to facilitate the transfer of heat between the reaction vessel and the Peltier devices.

One or both of the Peltier devices may be spring biased towards the other Peltier device.

The apparatus may comprise fastening means configured to hold the Peltier devices together to facilitate the transfer of heat between the reaction vessel and the Peltier devices.

The apparatus may comprise one or more further Peltier devices, and the thermally conducting chamber may be defined substantially between the first, second and further Peltier devices to enclose the reaction vessel.

The thermally conducting chamber may be configured to enclose a single reaction vessel or a plurality of reaction vessels.

The apparatus may comprise two or more connectable modules, each module comprising first and second Peltier devices and an associated thermally conducting chamber for enclosing one or more reaction vessels.

The apparatus may further comprise the reaction vessel.

The reaction vessel may be suitable for use in a polymerase chain reaction method, a molecular enzymatic process, an isothermal amplification process or an antibody mediated reaction.

According to a further aspect, there is provided a method of using the apparatus described herein, the method comprising:
positioning a reaction vessel in the thermally conducting chamber; and
cycling the temperature of the contents of the reaction vessel using the Peltier devices.

The method may form at least part of a polymerase chain reaction method, a molecular enzymatic process, an isothermal amplification process or an antibody mediated reaction.

The reaction vessel may comprise a body and a lid configured to be coupled together to contain the contents within the reaction vessel. The body and lid may each comprise a weldable portion. The thermally conducting chamber may comprise a cap portion configured to physically contact the lid of the reaction vessel during use. The cap portion may comprise a heating element configured to enable the lid to be heated independently of heating by the Peltier devices. The method may comprise using the cap portion to heat the lid to a predefined temperature when coupled to the body to cause fusion of the weldable portions and completely sealing of the contents within the reaction vessel before cycling the temperature (thus making the vessel biosecure).

According to a further aspect, there is provided a reaction vessel comprising a body and a lid configured to be coupled together to contain its contents therein, wherein the body and lid each comprise a weldable portion configured such that heating of the lid to a predefined temperature when coupled to the body causes fusion of the weldable portions to seal the contents within the reaction vessel.

The weldable portions may comprise corresponding flange portions of the body and lid.

The lid may have a generally rectangular shape comprising two major sides and two minor sides, and the flange portion of the lid may extend from the major sides and minor sides.

The lid may have a generally rectangular shape comprising two major sides and two minor sides, and the flange portion of the lid may extend from the minor sides only.

The reaction vessel may comprise a sealing film configured for adhesion to the flange portion of the body to temporarily seal (e.g. hermetically) the contents within the reaction vessel.

The lid may comprise a bung configured to close an opening in the body.

The weldable portion of the lid may comprise a weld bead formed around a perimeter of the bung. The weld bead facilitates indexing of the lid to the body and provides an increased surface area to weld the opening.

The reaction vessel may comprise fastening means configured to secure the lid to the body when the lid and body are coupled together.

The fastening means may comprise one or more clips.

The lid or body may comprise one or more upstands configured to guide the coupling therebetween.

The body may comprise a collar configured to inhibit or retard the transfer of heat from the lid to the contents of the reaction vessel during fusion of the weldable portions. The collar may be formed from a material which is less thermally conductive than the body (e.g. a thermally insulating material). The same material may be used to form the lid.

The body may have a generally rectangular cross-section defined by two major walls and two minor walls, and the major walls and/or minor walls may diverge towards the lid.

The major walls and/or minor walls may diverge at an angle of 1-2°. This may facilitate removal of the reaction vessel from the tooling during the moulding process.

The lid may be hingedly connected to the body.

One or both of the body and lid may comprise an identifier (e.g. barcode) to facilitate identification of the contents of the reaction vessel.

It will be apparent to the skilled person that the vessel comprises a base, or a base wall i.e. a surface that runs perpendicular to the lid when the lid is in position closing the vessel, and contacts the two major and two minor walls. The skilled person will appreciate that a structure without a base is not a vessel, since it is incapable of holding any liquid. The base may be flat, or may be curved. Where the base is flat, it may be perpendicular with the major and minor walls of the vessel.

The body may comprise one or more window portions for optical interrogation of the contents of the reaction vessel. In preferred embodiments the one or more window portions comprise the minor walls of the vessel. In some embodiments the window is located in the minor walls (i.e. the minor walls are made from an optically transparent material), and extends from the base of the vessel to the top of the vessel.

In preferred embodiments the window is not located in the base wall. In the same or additional embodiments the window is located in the minor walls, and is not located solely in the lower third of the minor walls.

The weldable portions of the lid and body may be formed from a thermoplastic or metal, the window portions of the body may be formed from an optically transparent thermoplastic, and the remainder of the body may be formed from a thermally conductive material.

The thermoplastic may comprise one or more of polypropylene and polycarbonate (or another material which is both biocompatible for the reaction process and is optically transparent).

The thermally conductive material may comprise a primary material loaded with a secondary material to increase the thermal conductivity of the primary material, the primary material may comprise one or more of polypropylene, glass, acrylic, nylon and polycarbonate, and the secondary material may comprise one or more of carbon, graphite flakes, graphite powder, ceramic, boron nitride and diamond powder.

The thermally conductive material may comprise 40-80% of the secondary material.

The thermally conductive material may comprise 50-80% of the secondary material.

The reaction vessel may have a volume of 20-120 ul, for example:
a) between 20-120 ul, or between 30-110, 40-100, 50-90, 60-80 or 70 ul;
b) at least 20 ul, for example at least 30, 40, 50, 60, 70, 80, 90, 100, 110 or at least 120 ul; and/or
c) less than 120 ul, for example less than 110, 100, 90, 80, 70, 60, 50, 40, 30, 20 ul.

The reaction vessel may have a wall thickness of 0.4-1.0 mm, and preferably around 0.6 mm. For example in some embodiments the reaction vessel may have a wall thickness of:
a) between 0.4-1.0 mm, or between 0.5-0.9, or 0.6-0.8 mm;
b) less than 1.0 mm, less than 0.9, 0.8, 0.7, 0.6, 0.5, 0.4 mm; and/or
c) at least 0.4 mm, or at least 0.5, 0.6, 0.7, 0.8 or at least 0.9 mm; or
d) 0.6 mm.

The reaction vessel may have a surface area to volume ratio of between 1:0.30 and 1:0.82, and preferably between 1:0.65 and 1:0.73. In some embodiments the reaction vessel has a surface area to volume ratio of:
a) between 1:0.3 and 1:0.82, for example between 1:0.3 and 1:0.7; 1:0.4 and 1:0.6, or between 1:0.65 and 1:0.73; and/or
b) at least 1:0.3, for example at least 1:0.4, 1:0.5, 1:0.6, 1:0.65, 1:0.7, 1:0.73, 1:0.8, 1:0.9,

The reaction vessel may be suitable for use in a polymerase chain reaction method, a molecular enzymatic process, an isothermal amplification process or an antibody mediated reaction.

The contents may comprise a DNA/RNA sample, one or more primers and one or more polymerisation enzymes. These may be lyophilised in the vessel to reduce the number of pipetting steps and remove cold-chain issues.

It will be apparent to the skilled person that the unique dimensions of the reaction vessel of the invention requires unique ancillary equipment. As per WO 2019/207308 the present inventors have found particular advantages to the use of centrifugation in the context of nucleic acid amplification.

In view of this, the invention also provides a centrifuge that is capable of holding and centrifuging the vessel of the present invention. The centrifuge of the invention comprises at least two apertures configured to hold the vessel of the invention.

In some embodiments the centrifuge of the invention comprises a rotor with at least two apertures wherein each aperture comprises two major and two minor sides and has a substantially rectangular, or rectangular cross face.

According to a further aspect, there is provided a method of making the reaction vessel described herein, the method comprising:
injection moulding an optically transparent thermoplastic to form the weldable portions of the lid and body and the window portions of the body; and
injection moulding a thermally conductive material to form the remainder of the body.

The optically transparent thermoplastic may be injected into a polished section of a mould to form the window portions.

The invention also provides an apparatus of the invention as defined herein wherein the reaction vessel is a reaction vessel according to the invention as defined herein.

The invention also provides a system comprising a reaction vessel according to the invention as described herein and an apparatus according to the invention as described herein.

The invention also provides a kit comprising a reaction vessel according to the invention as described herein and a centrifuge according to the invention as described herein.

The invention also provides a kit comprising an apparatus according to the invention as described herein and a reaction vessel according to the invention as described herein.

The invention also provides a kit comprising an apparatus according to the invention as described herein and a centrifuge according to the invention as described herein.

The invention also provides a kit comprising an apparatus according to the invention as described herein, a centrifuge according to the invention as described herein, and a reaction vessel according to the invention as described herein.

According to a further aspect, there is provided an apparatus as substantially described herein with reference to, and as illustrated by, the accompanying drawings.

The steps of any method disclosed herein do not have to be performed in the exact order disclosed, unless explicitly stated or understood by the skilled person.

Corresponding computer programs (which may or may not be recorded on a carrier) for implementing one or more of the methods disclosed herein are also within the present disclosure and encompassed by one or more of the described example embodiments.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying schematic drawings, in which:—

FIG. 1.1 shows a thermally conducting chamber from above;

FIG. 2.1 shows a reaction vessel in an open state from the side;

FIG. 2.2 shows the reaction vessel of FIG. 2.1 from the side in cross-section;

FIG. 2.3 shows the reaction vessel of FIG. 2.1 from the front;

FIG. 2.4 shows the reaction vessel of FIG. 2.1 in isometric view;

FIG. 2.5 shows another reaction vessel in an open state in isometric view;

FIG. 2.6 shows the reaction vessel of FIG. 2.5 from the side;

FIG. 2.7 shows the reaction vessel of FIG. 2.5 from the front;

FIG. 2.8 shows the reaction vessel of FIG. 2.5 from above;

FIG. 3.1 shows another thermally conducting chamber from the front;

FIG. 3.2 shows the thermally conducting chamber of FIG. 3.1 from the front in cross-section;

FIG. 4.1 shows another thermally conducting chamber from the front;

FIG. 4.2 shows the thermally conducting chamber of FIG. 4.1 from the front in cross-section;

FIG. 5.1 shows another thermally conducting chamber from the front;

FIG. 5.2 shows the thermally conducting chamber of FIG. 5.1 from the front in cross-section;

FIG. 5.3 shows the thermally conducting chamber of FIG. 5.1 from above in cross-section;

FIG. 5.4 shows the thermally conducting chamber of FIG. 5.1 in exploded isometric view;

FIG. 6.1 shows another thermally conducting chamber from the front;

FIG. 6.2 shows the thermally conducting chamber of FIG. 6.1 from the front in cross-section;

FIG. 6.3 shows the thermally conducting chamber of FIG. 6.1 in exploded isometric view;

FIG. 7.1 shows another reaction vessel in isometric view;

FIG. 7.2 shows the reaction vessel of FIG. 7.1 from the side in cross-section;

FIG. 7.3 shows the reaction vessel of FIG. 7.1 from the front;

FIG. 7.4 shows another reaction vessel in isometric view;

FIG. 7.5 shows the reaction vessel of FIG. 7.4 from the side in cross-section;

FIG. 7.6 shows the reaction vessel of FIG. 7.4 from the front;

FIG. 8.1 shows another thermally conducting chamber from the front;

FIG. 8.2 shows another thermally conducting chamber from the front;

FIG. 9.1 shows another thermally conducting chamber from the front;

FIG. 9.2 shows the thermally conducting chamber of FIG. 9.1 from the front in exploded view;

FIG. 9.3 shows the thermally conducting chamber of FIG. 9.1 from the side in exploded view;

FIG. 10.1 shows another thermally conducting chamber from the front;

FIG. 10.2 shows the thermally conducting chamber of FIG. 10.1 from the front in exploded view;

FIG. 10.3 shows the thermally conducting chamber of FIG. 10.1 from the side in exploded view;

FIG. 11 shows surface-to-volume ratios for different volumes of reaction vessel;

FIGS. 12.1-12.6 show a process for welding and cutting a flanged reaction vessel before placement in a thermally conducting chamber; and

FIGS. 13.1-13.4 show another process for welding and cutting a flanged reaction vessel before placement in a thermally conducting chamber.

FIG. 14—Vessel Inserted, Cooled, Ready for Weld

FIG. 15—Welding Unit Down, Weld Vessel

FIG. 16—Welding Unit, Vessel, Ejector Down, Thermal Cycle

FIG. 17—Reaction Vessel Before and After Weld

FIG. 18—Thermal Conducting Chamber (TCC)

FIG. 19—Thermal Conducting Chamber (TCC)

### DESCRIPTION OF SPECIFIC ASPECTS/EMBODIMENTS

### The Reaction Vessel

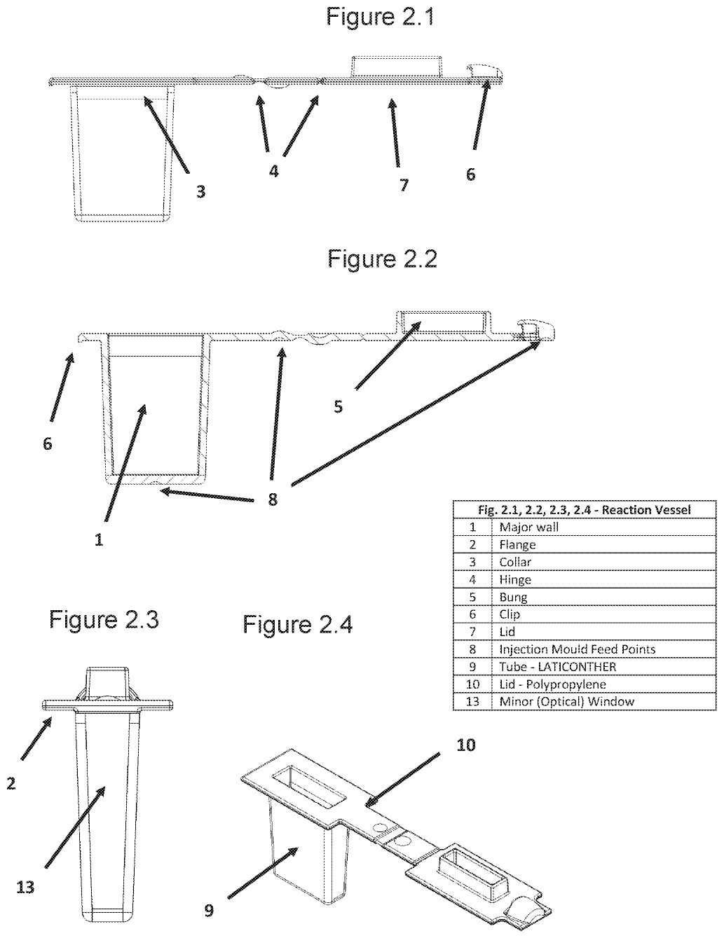

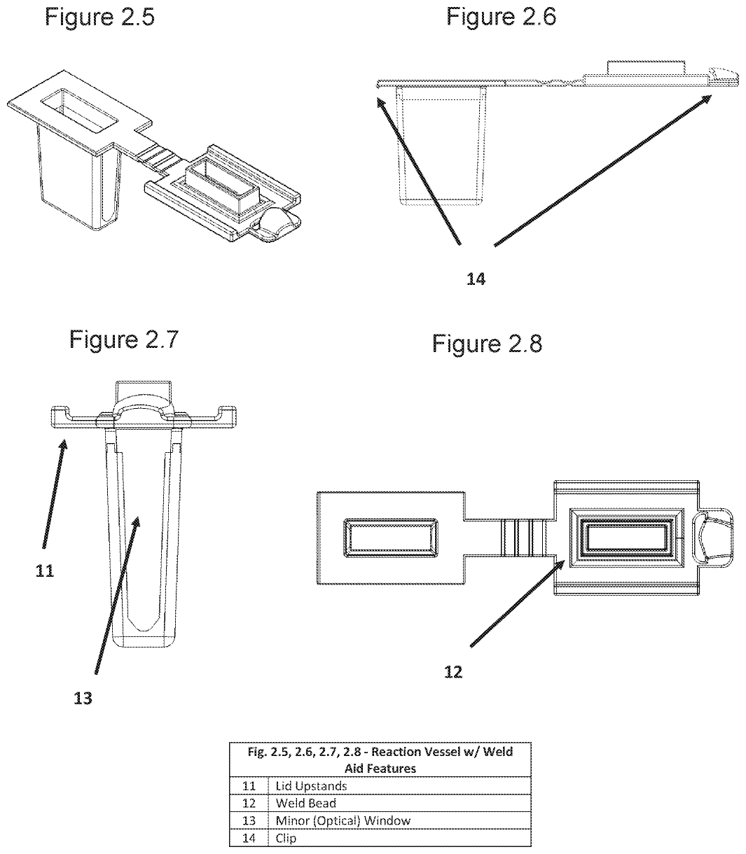

Different embodiments of the reaction vessel are shown in FIGS. 2, 7 and 11 (including sub-figures):

### FIG. 2 (Flanged Vessel)

A schematic of the vessel to show the key features of a flanged vessel 10 with major 9 (high surface area for thermal conduction via direct contact with the Peltier) and minor walls 13 (for optical interrogation). The hinge mechanism 4 and also the clip 6 is shown. Key design features to facilitate:
vessel handling via the extended flange 10 as well as the clip 6.
welding of the lid 10 to the vessel body by designing in a weld bead 12 (higher surface area for welding the bung and opening to the lid)
temporary filming of the vessel with an adhesive or heat-based film onto the flange area to cover the vessel opening to prevent egress of freeze-dried reagent from the vessel or ingress of air/moisture that would ‘spoil’ the freeze-dried reagent prior to use

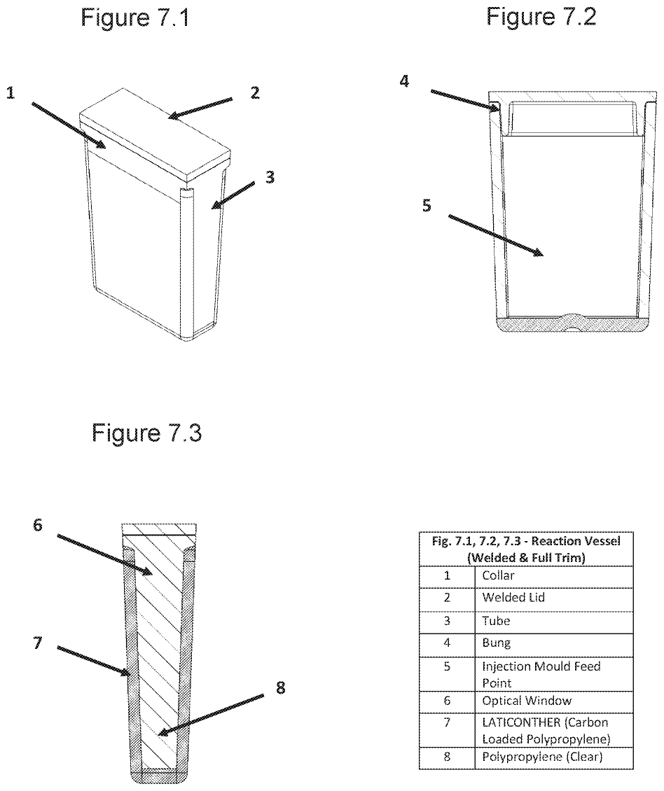

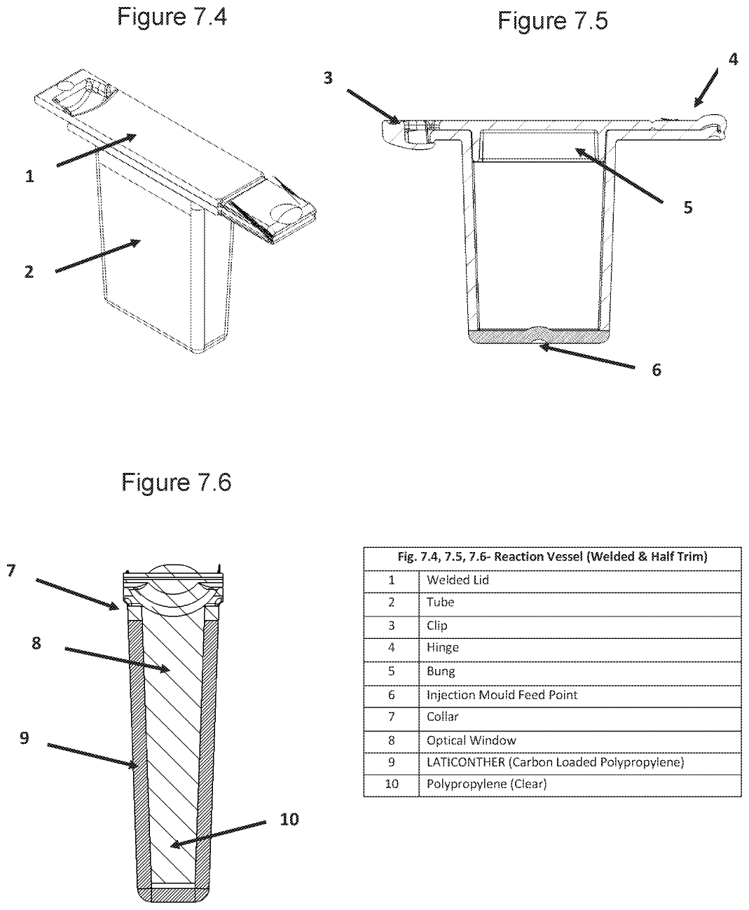

### FIG. 7 (Trimmed Vessel)

The schematics of FIGS. 7.1-7.3 show a vessel that has the flange trimmed off 2, 7 on the longest sides after welding to allow the whole vessel to sit substantially within the Thermal Conducting Chamber. This ensures that the whole vessel and the contents are substantially at the same temperature during the thermally cycling process.

The clip and hinge may sit outside the Thermal Conducting Chamber 6-8 or may be trimmed. Preferably trimming off the flange, clip and hinge.

The embodiments share identical feature sets other than one (FIGS. 7.4-7.6) has the addition of a flange that provides further surface area for the welding process and will be more easily manipulatable by an operative wearing full Personal Protection Equipment (PPE).

The reaction vessel of FIG. 2 is formed as a single piece using a two-shot injection moulding process 9, 10, 13. The vessel being formed of optically clear polypropylene in some sections 10, 13 and the remainder being formed from carbon loaded polymer 9. Suitable loadings are in the range of 50-60% carbon, but other thermally conductive materials and suitable compositions are known in the art including boron nitride or other ceramics and differing forms of carbon.

The described reaction vessels maximise the surface area to volume ratio of the reaction and critically the proportion of it that is in physical contact with the walls. A design limitation is the requirement to get liquids into the vessel with a pipette tip and not introduce the burden of having to centrifuge the reaction as seen in the use of glass capillary-based vessels.

The vessel consists of substantially three sections: the reaction chamber (tube) 9, the optical window 13 and the lid 10.

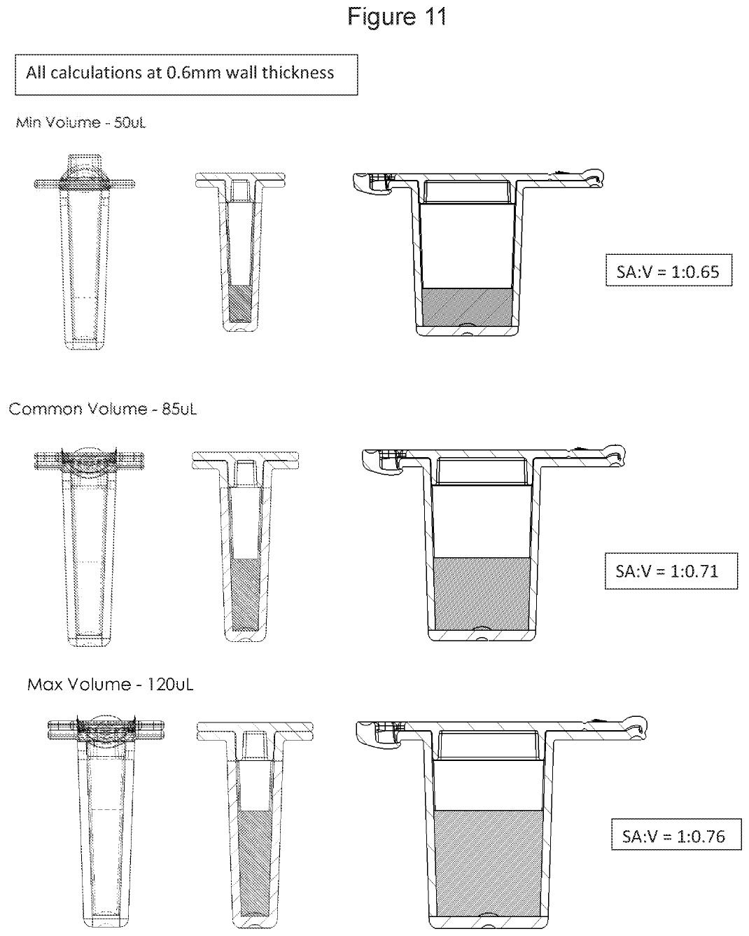

### FIG. 11 (Surface-to-Volume Ratios)

FIG. 11 shows calculations of the required high Surface Area to Volume ratios relating to vessel wall thicknesses (and hence varying internal reaction volumes) and vessel surface area. The reaction vessel has been designed to hold thermal cycling reactions in the range 20-120 ul of total volume, and preferably in the range 50-100 ul. The reaction vessel therefore has a surface area to volume ratio of between 1:0.30 (sample volume of 7.21 ul) and 1:0.82 (sample volume of 190.28 ul), and preferably between 1:0.65 (sample volume of 50 ul) and 1:0.73 (sample volume of 100 ul). In contrast, a conventional PCR tube with a sample volume of 50 ul has a surface area to volume ratio of 1:1.3.

The reaction vessel of FIG. 2 is formed of two opposing major walls 1 and two minor walls 13 and there is a taper in the minor wall in the region of 1-2 degrees such that it can form an interference fit between the two thermoelectric devices.

The major walls and the base of the vessel are formed from the carbon loaded polymer and it is these surface that form the interference fit with the working facing of the thermoelectric coolers.

Both of the minor walls of the vessel are formed from the clear polymer, thus the base and both major walls are moulded and then the optical windows, top section of the reaction chamber and lid are second shot moulded as part of the two-shot injection moulding process. The wall thicknesses of the two materials are in the range of 0.4 to 0.8 mm in thickness but preferably are 0.6 mm thick.

The optical window 13 is formed in a highly polished section of the mould to ensure optical clarity. The polypropylene has been selected both because of its optical properties, biocompatibility for the process and its melting temperature and hence suitability for the welding process.

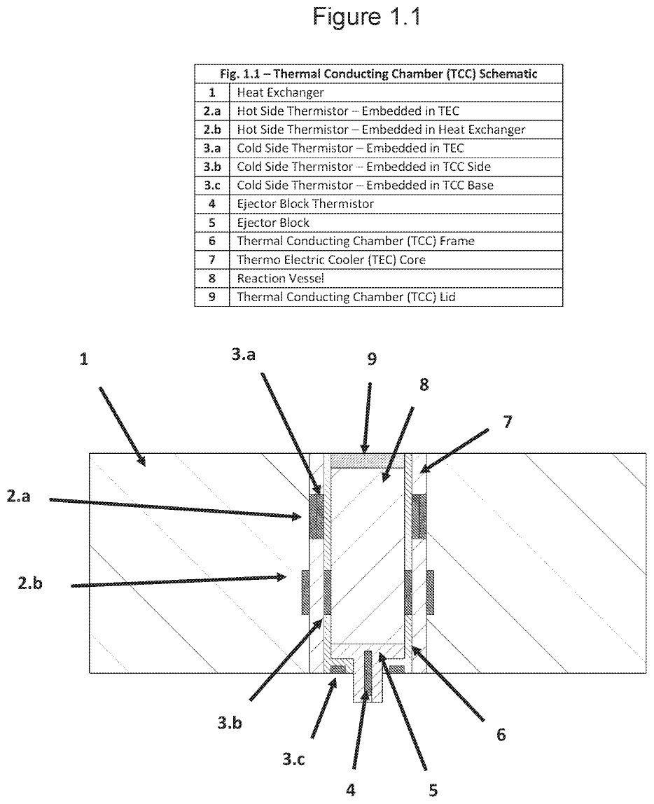

The top of the reaction chamber is surrounded by a ring of the polypropylene material to form the bottom surface for the weld, this additional material is highlighted in FIG. 1A. The lid, though clear, is not normally used for optical interrogation.

The hinge 4 brings the lid reliably back to the correct position for the welding process to take place as well as ensuring the lid is retained with the reaction chamber/tube and this surface may be optionally utilised for the addition of a barcode sequence (for assisting sample tracking and programming of the instrument).

The lid 2, 10 is sealed permanently shut by a welding process, in the case of polypropylene this requires temperatures in the region of 160-250° C. to be applied. The welding temperatures can either be facilitated by a separate device, a “welding station”, or in the case of a heater element being employed in the instrument then this could be performed in situ. The thermal energy required for the welding process may be applied from above only, from above and below and with or without a requirement for pressure to assist in ensuring a consistent and permanent seal between the two mating surfaces 7, 10. The lid feature may be provided with a concentric ring of additional material 12 that will provide additional material under the welding conditions in order to ensure a continuous seal around the entirety of the surface to be welded.

### The Thermally Conducting Chamber (TCC)

Different embodiments of the TCC are shown in FIGS. 1, 3-6 and 8-10 (including sub-figures):

### FIG. 1

A schematic of the Thermal Conducting System and lid 5, 6, 8. The vessel is placed within two opposing Peltier devices each of which have heat sinks 1 on the surface not in contact with the vessel.

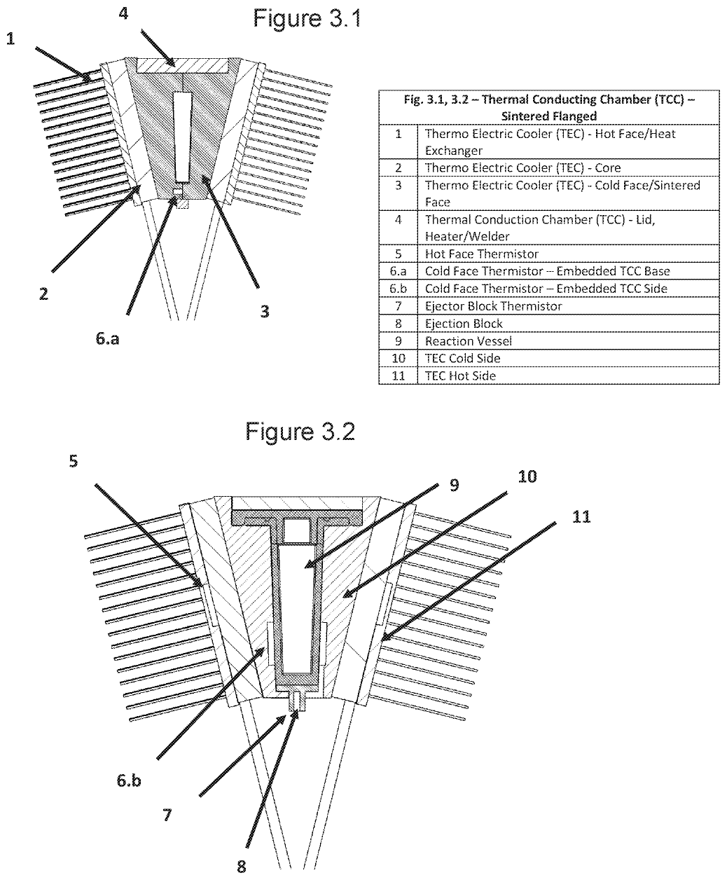

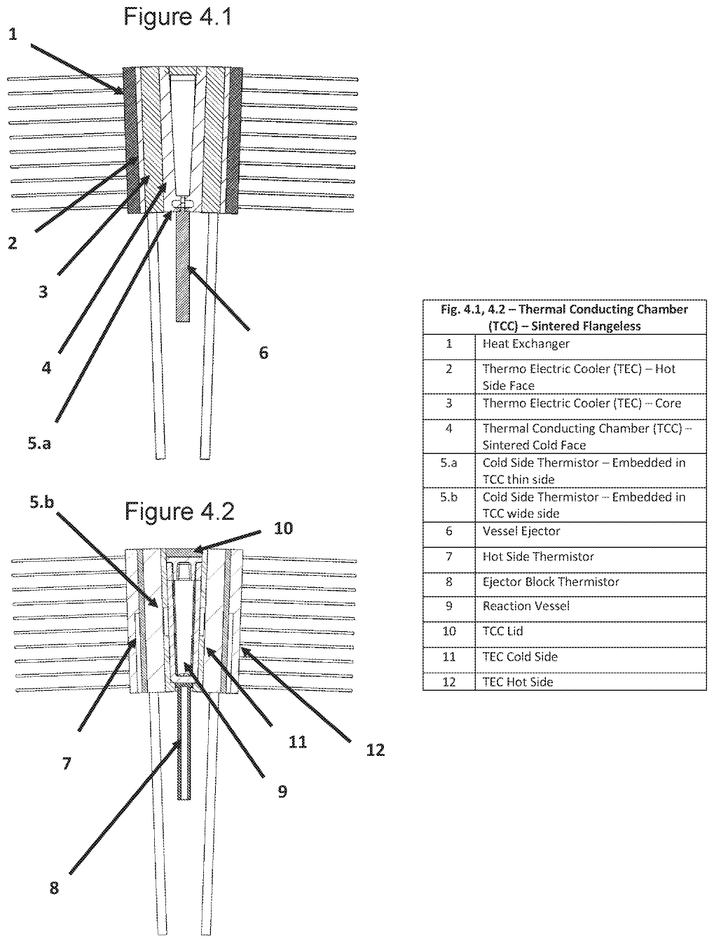

### FIGS. 3 and 4 (Sintered TCC)

The drawings show a specially designed Peltier 2 where the side in contact with the vessel 8 is shaped to receive a vessel with a flange (FIG. 3) and without a flange (FIG. 4). Close thermal contact with the vessel ensures rapid thermal transfer in/out of the vessel and thereby reduces overall thermally cycling time and ability to report a result more quickly.

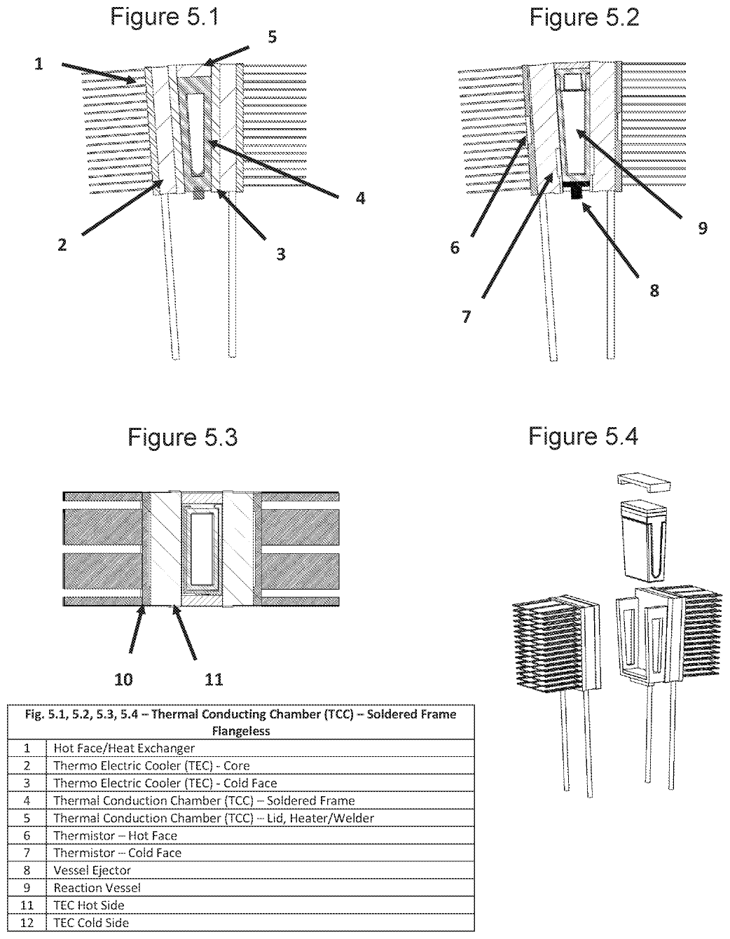

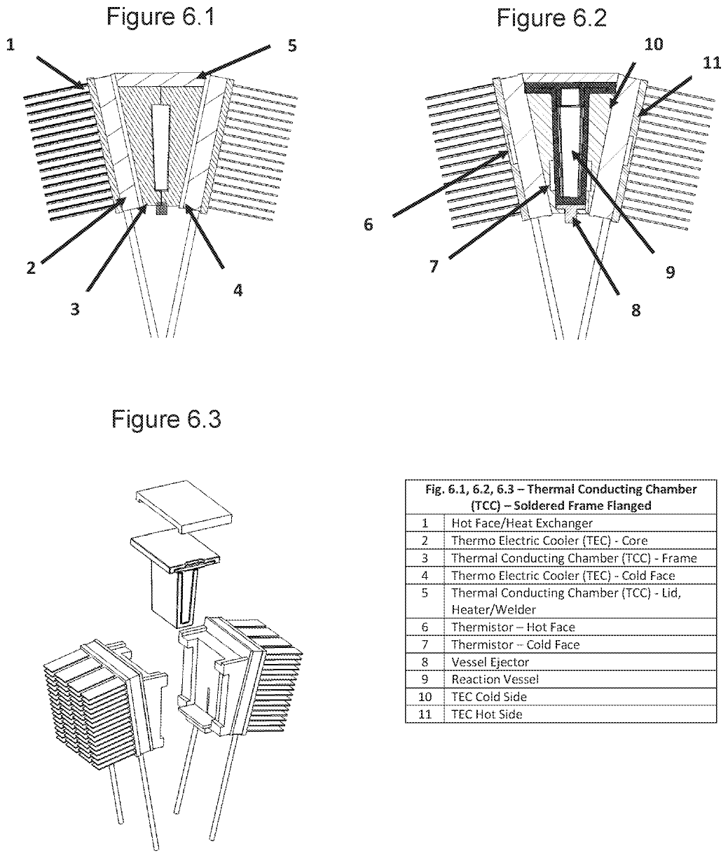

### FIGS. 5 and 6 (Soldered TCC)

The drawings show a thermally conductive chamber 4 made from a thermally conducting material like aluminium or copper soldered onto one face of a Peltier to receive the vessel that could be flangeless (FIG. 5) or flanged (FIG. 6). Close thermal contact with the vessel ensures rapid thermal transfer in/out of the vessel and thereby reduces overall thermally cycling time and ability to report a result more quickly. The lid 5 is made of thermally conductive material and completes the thermally conductive chamber that houses the vessel in a substantially isothermal environment, the temperature of which is dictated by the cycling temperature set points.

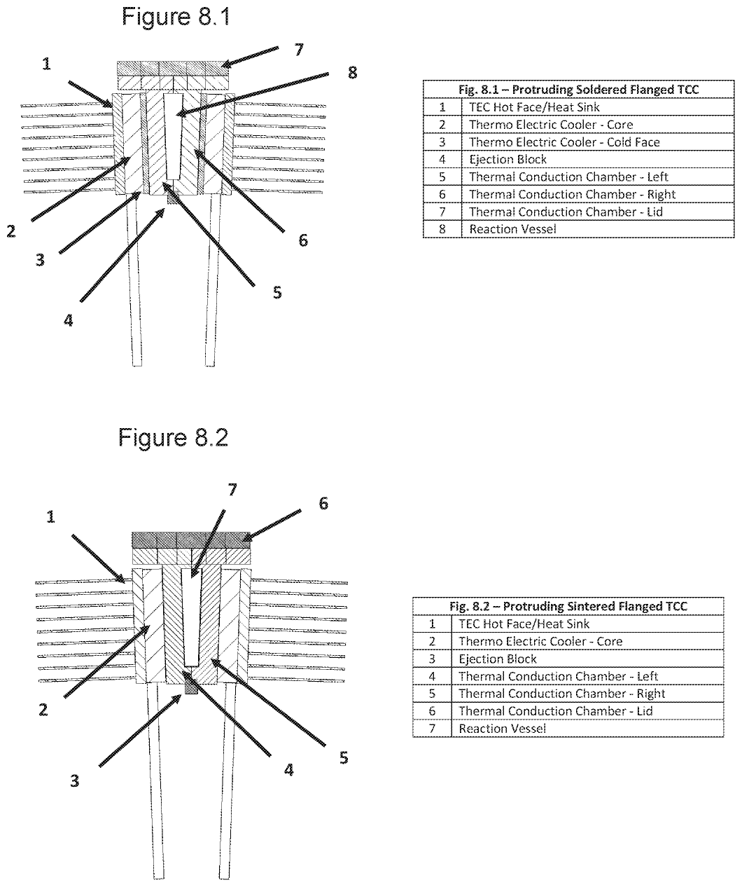

### FIG. 8 (Metal TCC)

FIG. 8.1 shows a flanged vessel 8 sitting within a thermally conducting chamber 6, 7 that is made from metal or other suitable thermal conductor that is soldered to the face of the Peltier receiving the vessel such that the walls of the thermally conducing chamber extend outside of the Peltier faces. The lid 7 is made of thermally conductive material and completes the thermally conductive chamber that houses the vessel in a substantially isothermal environment, the temperature of which is dictated by the cycling temperature set points.

The flange 7, 8 sits within the metal holder and acts as an anvil during the soldering process.

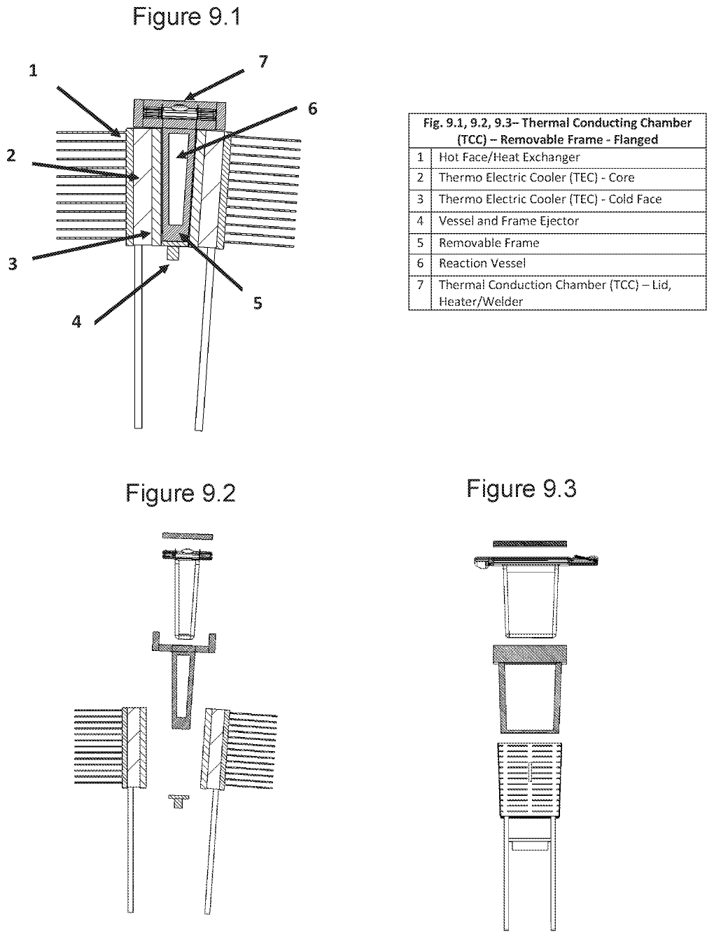

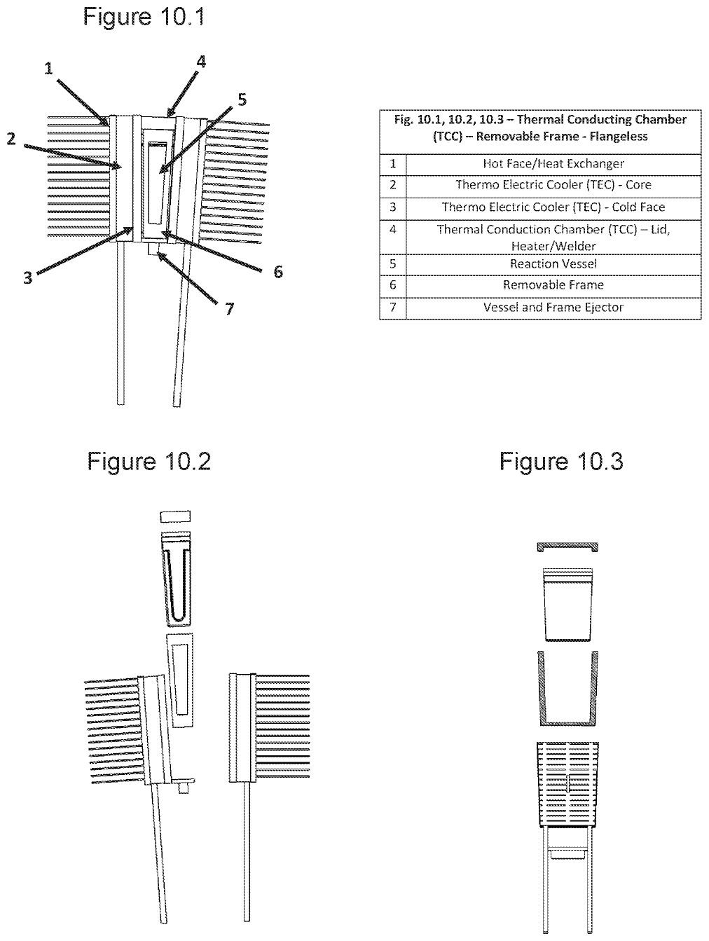

### FIGS. 9 and 10 (Removable Frame TCC)

FIG. 9 shows an embodiment where the thermally conducting chamber 5, made of metal or similar conducting material is a free-standing entity. The vessel which could be flanged (FIG. 9) or flangeless (FIG. 10) is placed into the metal carrier and inserted into the receiving Peltiers 3. The whole assembly is then kept together under positive mechanical pressure such that the Peltier faces contact the major walls of the vessels for efficient thermal transfer. At the end of the process the metal carrier and vessel are removed from the assembly and the process is repeated for further test vessels.

The concept of the TCC (FIG. 1) is defined by substantially all of the surface of the reaction vessel being in thermal contact with an actively temperature-controlled surface. Devices such as the Lightcycler™ from Idaho Technology and Corbett Rotorgene™ describe placing reaction vessels in isothermal chambers and yet these do not meet the definition. In the case of the Lightcycler™ they have plastic heads to the glass capillaries and these sit in a metal holder outside the air oven therefore the reagents are in the chamber and yet a proportion of the vessel is not. Similarly, the Rotorgene™ has a spinning holder and again this will not be thermally cycling at the same rate as the chamber. Additionally, they rely on heating through air as opposed to having a physical contact with a material surface, so while they may be substantially the same temperature there is no physical contact of surfaces and both are limited in volume to about 30 ul.

The two Peltier devices (FIGS. 3-6) have heat sinks either forming their base face or soldered to the base face in order to maximise their ability to reject heat. There is provided a fan and speed controller for each of these such that a maximum amount of heat can be rejected and by so doing maximise the cooling rate of the devices. Heating can be assisted by pure resistance-based heating of the devices, yet cooling is entirely reliant upon heat pumping. In order to maximise heat pumping it is necessary to reject the pumped heat as rapidly as possible. There is a temperature sensor measuring the temperature of the cold face of the Peltier (FIG. 1) which in conjunction with the temperature sensor on the hot face and fan speed modulation ensures intelligent/predictive cooling of the hot face in an environment where power conservation is critical, such as the battery powered portable device envisaged here. Heat pipe-based heat exchangers may be used to maximise heat transfer particularly during cooling of the vessel contents.

The cold face of the Peltier devices could be manufactured from Ceramic such as aluminium oxide or nitride, but other materials could include aluminium or similar metals and ceramics known in the art. Aluminium nitride has the advantage of higher thermal conductivity than aluminium oxide and being compatible with the methods of manufacture such as sintering (FIGS. 3 and 4).

Each Peltier and heat exchanger will have temperature sensors placed on each of the hot and cold sides of the Peltiers, within the TCC 5, 6a and 6b, heat exchanger 1 or tube ejection mechanism 4 (FIG. 1), to ensure optimal temperature control within the vessel contents and maximal heat removal on the hot side of the Peltier together with conservation of energy during the process.

The key is that the Peltiers themselves form the holder that contacts the thermally conductive major walls of the vessel (preferably directly) and as such remove the thermal junctions between Peltier and holder and holder and vessel and reduce this to a single thermal junction between Peltier and vessel.

By chamber the applicants mean that all surfaces of the reaction vessel are substantially in good thermal contact with an actively temperature-controlled surface. The only exception is a small section in the optically clear minor wall 10, necessitated by the requirement to observe the fluorescence emission resulting from the RT-qPCR process taking place in the sealed vessel and potentially clip 3 and hinge 4 mechanism of the lid of the vessel (FIG. 7.5).

Practically, this is provided by thermal contact of the major walls 1 (see FIG. 2) of the vessels with the working face of the thermoelectric coolers and the base and minor walls are contacted by a thin strip of metal 7 that is itself in contact with the working face of the two devices 4 and the top of the vessel similarly by a metal lid 7. Hence the vessel is substantially isothermal with the prescribed temperature during the process but allowing for differences due to temperature transfer lag between different materials (FIG. 1).

At the top of the chamber the lid 10 is in thermal contact with a metallic strip that again bridges the two cold faces of the thermoelectric devices and is substantially isothermal with them or can be actively temperature controlled if required. This top section of the chamber is arranged such that it can be opened, a vessel put in place and then the lid shut. This has the additional benefit of allowing application of downward pressure ensuring good thermal contact at the base and walls of the vessel. This could take the form of a strip of metal backed with an insulative material to prevent heat loss from the top of the chamber.

As the vessel goes into the chamber in its entirety then means must be provided for the ejection of a reaction vessel at the end of the direct RT-qPCR process (FIGS. 1, 3 and 4). This is provided by an ejection plate that forms part of the thermally conducting chamber that holds the vessel and is made of the same material. Doing so raises the plate from the base of the TCC and pushes the reaction vessel up and out sufficiently that it can be removed by the operator. At the same time, it is envisaged that a cam system could be used to connect the operation of lid of the device to the ejection plate, providing means to automatically eject the vessel as the lid is raised.

In terms of thermal control, a circuit is provided for monitoring the temperature of each of the Peltiers independently. This means one thermistor or other temperature sensing device per thermoelectric controller (FIGS. 1, 3 and 4). A circuit is provided that monitors the temperature and alters the supplied current accordingly to ensure that the desired thermal profile is followed. In an alternate embodiment, there are provided two temperature measurement sensors per TEC device. One of these may be mounted at the base face (FIGS. 3, 5) and second at the working face (FIGS. 3, 6), the base face is that to which the heatsink is attached, the advantage of doing so would be the ability to in effect set the ambient temperature of the base face by varying the speed of the associated fan and heatsink. Another temperature sensor may be mounted in the piston that holds the ejection mechanism. When heating is required imminently it would be possible to allow the heatsink temperature to rise, such that this heat could then be rapidly pumped into the working face and similarly when cooling is about to be required the fan could be sped up to make the heatsink cooler and hence drop the Delta T making for more efficient cooling. The temperature sensors may also be placed within the body of the TCC and/or the ejection plate.

### The Welding Process

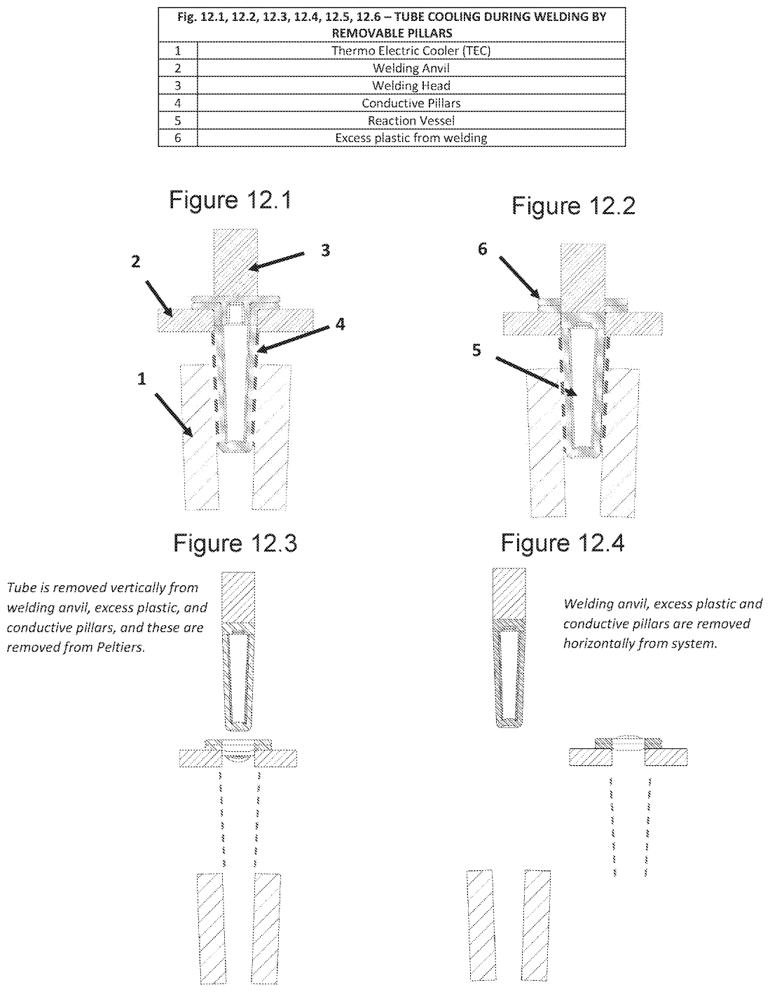

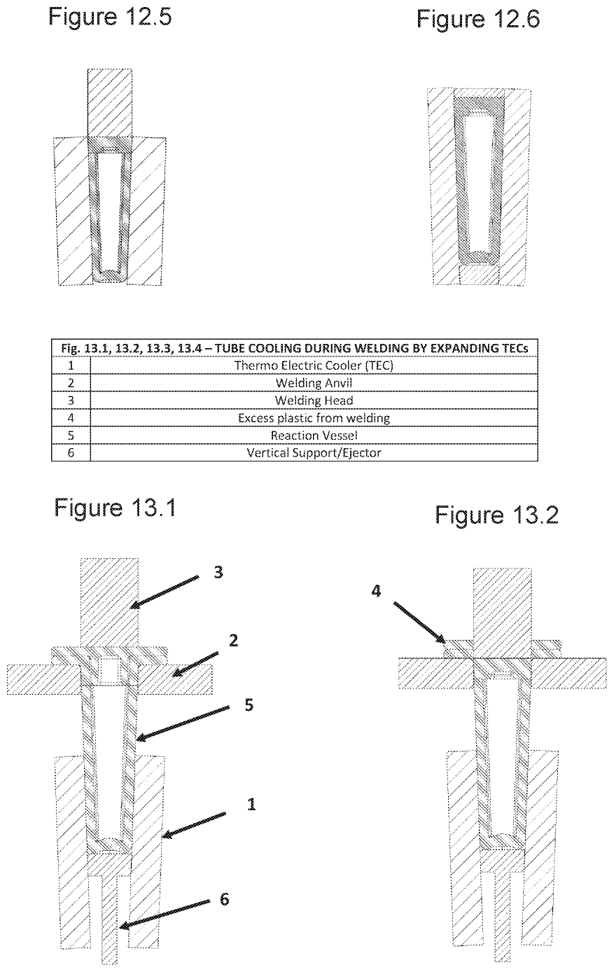

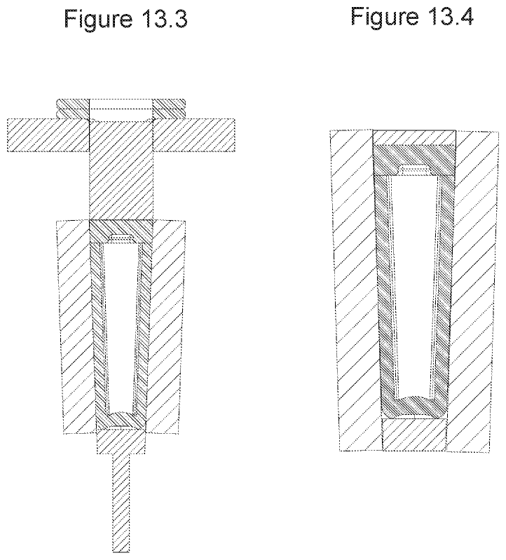

During the welding process, it is important that the thermolabile contents of the vessel are protected from heat damage. FIGS. 12 and 13 (including sub-figures) show two different examples of how this can be achieved. In both examples, the contents of the vessel are cooled by the Peltiers during the welding process, but different means are used to ensure that there is sufficient transfer of heat between the Peltiers and contents.

### FIG. 12 (Removable Pillars)

This welding process requires the flanged vessel to be held in position in a retaining structure referred to herein as the welding anvil 2. The anvil allows the heat and downward compression pressure from the welding head 3 to produce a weld on the reaction vessel 5 (comprising the lid and vessel flange). The welding head is kept at a temperature of between 180-250° C. for a predefined period of time while a force is exerted over the area to be welded.

The welding head may have a cutter, or be attached to a non-stick heat-spreading metal plate having a cutter, to remove the flange of the vessel such that very little (if any) of the flange remains after welding and cutting. The welding head 3 then presses the flangeless tube into the TCC after the metal holding structure 2,4 used during the welding process is removed. The welding head or the heat-spreading plate then serves as the cap portion of the TCC.

As shown in the figure, the vessel is placed in the welding holder (FIG. 12.1). The welding head is then heated to the requisite temperature and the excess plastic (flange, hinge and clip) is removed while the Peltiers keep the vessel contents to 20-30° C. (FIG. 12.2). The vessel is taken out of the welding structure (FIG. 12.3) and the welding structure removed with the waste plastic (FIG. 12.4). Next, the welding head (heater switched off and allowed to cool down to ambient temperature) is used to press the vessel into the TCC (FIG. 12.5) which then sits within the Peltier faces ready for the biological process to commence (FIG. 12.6).

### FIG. 13 (Expanding TECs)

In this example, an ejection mechanism 6 at the bottom of the TCC is used to raise and hold the vessel at a pre-determined position where the thermolabile contents are at the correct height to be cooled by the Peltiers during the welding process (FIG. 13.1). The contents of the tube are kept cool with the two Peltiers 1 in cooling mode acting on the major walls of the vessel and the vessel is further held in place by the welding anvil 2. The Peltier faces in contact with the vessel are pushed closer together mechanically so as to allow the requisite angle for the Peltier faces to contact the lower portion of the raised vessel. Next, the welding head 3 or heat-spreading plate welds the vessel and cuts the excess plastic 4 so that it can be removed (FIG. 13.2). The vertical support/ejector 6 is then lowered to the running position before the welding head or heat-spreading plate pushes the flangeless vessel into the TCC (FIG. 13.3). A mechanism allows the Peltier faces to be opened to allow the vessel and Peltiers to contact each other in the lowered position so that the reaction process can commence (FIG. 13.4).

### Vessel Welding Process

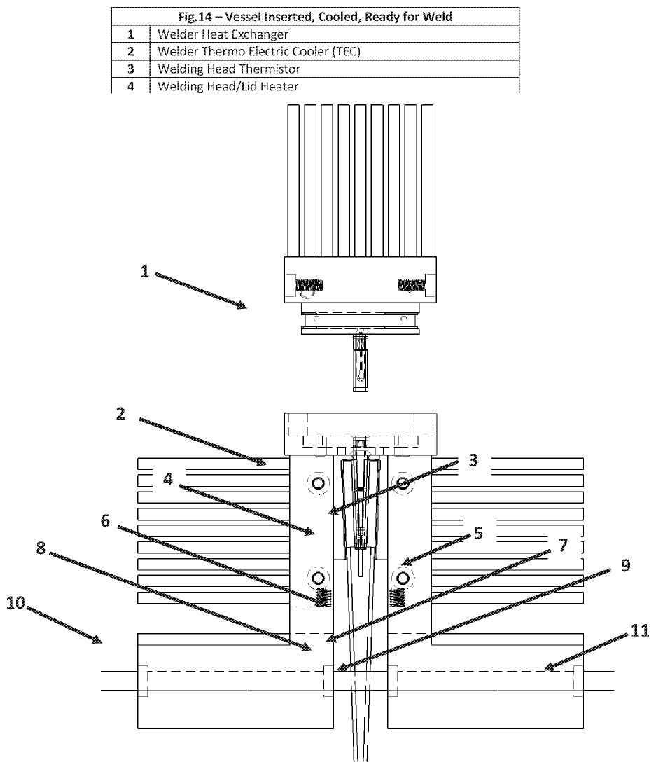

### FIG. 14: Pre-Weld

1 Vessel is placed in the holding tray (5) on the instrument
2 Vessel ejector (7) is in the fully ‘up position’ so it supports the base of the vessel during the welding process
3 Welding head (4) is positioned above the vessel lid
4 Welding head gets up to welding temperature as measured by built in temperature sensor (3)

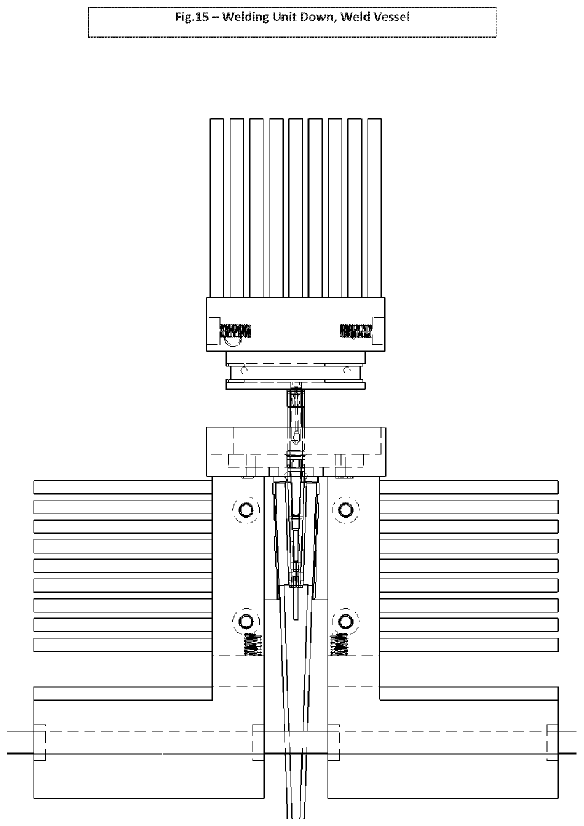

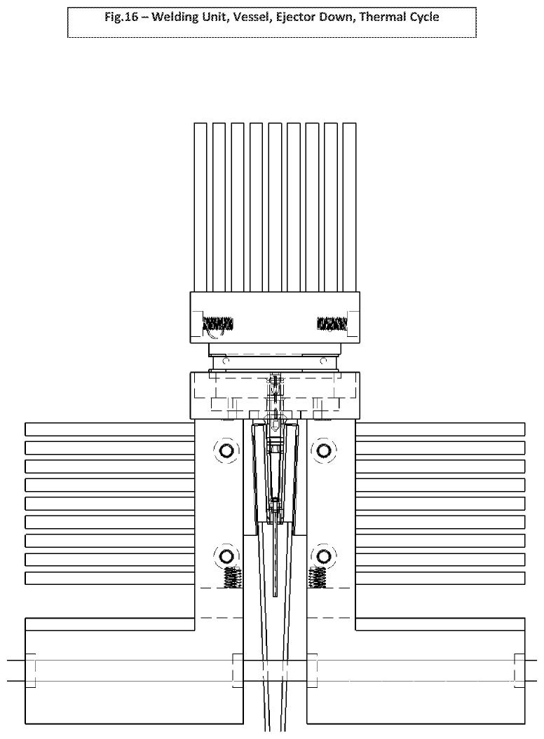

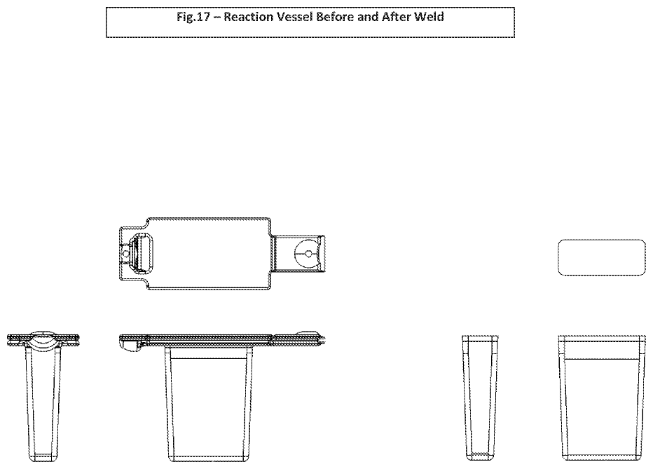

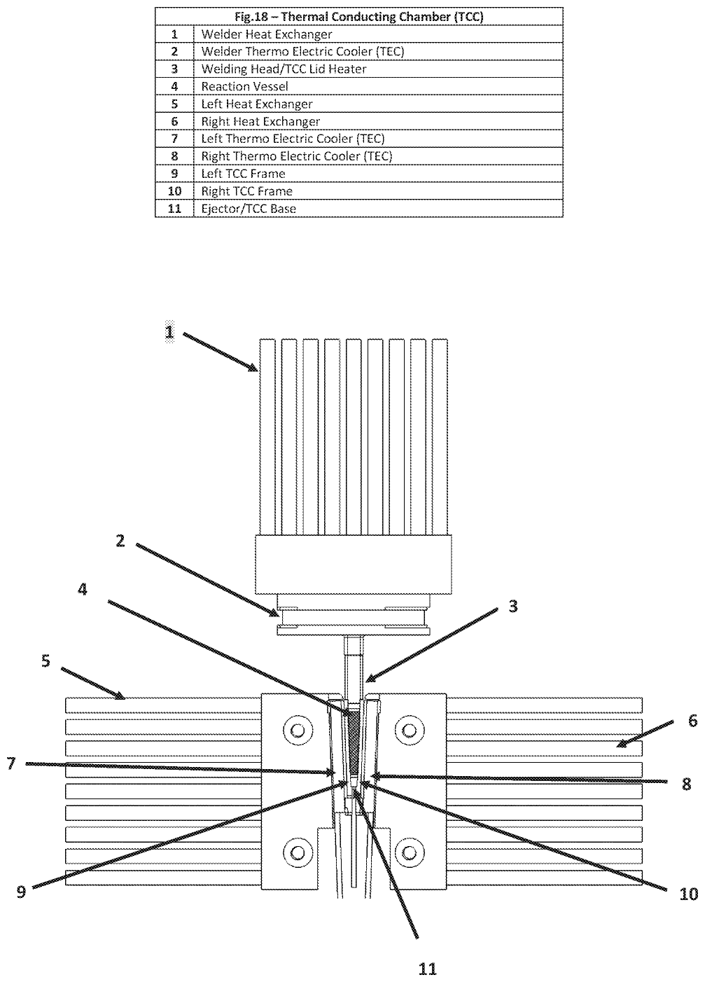

### FIG. 15: Welding

1 Vessel is placed such that the two TECs (9,10) are in contact with the vessel and the TECs are pre-cooled to ensure the contents of the vessel are kept below 40 C during the welding process
2 The welding head is placed on the vessel lid
3 After a pre-set temperature/time to allow welding of the vessel lid to the flange and pushed though the opening in the vessel holder. See FIG. 17
4 The weld head is cooled using the TEC (2)

### Thermal Cycling

### FIG. 16: Thermal Cycle

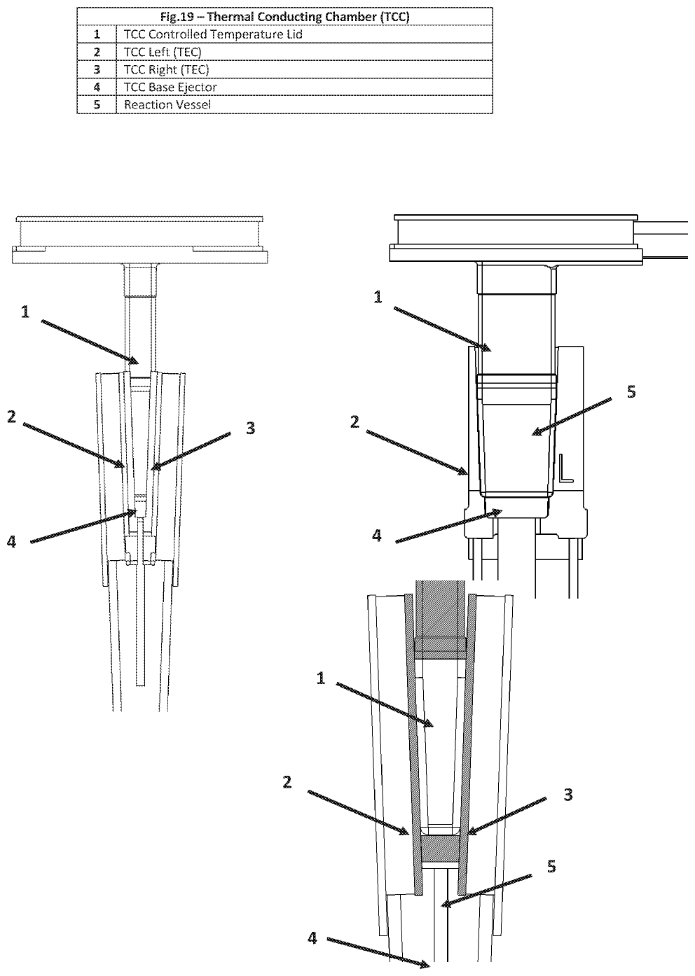

1 The TECs (9,10) move to make good mechanical/thermal contact with the vessel (6)
2 The Ejector (7) supports the base of the tube mechanically/thermally
3 FIG. 19: The Controlled Temperature Lid (4) is placed in position such that the reaction vessel (5) sits within a substantially isothermal environment (TCC) between the TCC right (3), TCC Left (2) and Ejector (4).

The temperature of the Controlled Temperature lid (1) will be under process control to ensure the contents of the vessel and most of the vessel are substantially isothermal during the thermal cycling process

### The Process for In-Field Detection

1. The user is provided with a reaction vessel containing a lyophilised diagnostic reaction, this will be sealed by means of an adhesive, UV glue or thermally applied film;
2. The user scans the supplied barcode, this programmes the thermal profile for the portable diagnostic platform and allows the user to assign unique patient information;
3. The user removes the film and resuspends the reaction with buffer via means of a supplied fixed volume pipette;
4. The user adds the specified volume of crude biological sample with the supplied fixed volume pipette;
5. The user seals the lid by closing the hinged lid closed and placing the vessel into the welding instrument;
6. The instrument indicates when the welding is complete;
7. The reaction is transferred to the TCC and the run is started;
8. The instrument automatically analyses the data and makes the result known to the user; and
9. The user is prompted the run is complete, the vessel is discarded and the process can be repeated.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

### The Invention is Also Defined by the Following Numbered Paragraphs

1. An apparatus comprising:
first and second Peltier devices arranged in substantial opposition to one another; and
a thermally conducting chamber defined substantially between the first and second Peltier devices and configured to enclose a reaction vessel during use to facilitate a transfer of heat between the reaction vessel and the Peltier devices.

2. The apparatus of paragraph 1, wherein the thermally conducting chamber is configured to physically contact all, or substantially all, of the external surface area of the reaction vessel during use.

3. The apparatus of paragraph 1 or 2, wherein the reaction vessel comprises one or more window portions for optical interrogation of its contents, and wherein the thermally conducting chamber is configured to physically contact substantially all of the external surface area of the reaction vessel during use except for the one or more window portions.

4. The apparatus of any preceding paragraph, wherein the thermally conducting chamber comprises two or more discrete portions configured to physically contact one another to enclose the reaction vessel.

5. The apparatus of any preceding paragraph, wherein the thermally conducting chamber is at least partially formed from a first face of one or both Peltier devices.

6. The apparatus of any preceding paragraph, wherein the thermally conducting chamber comprises a frame of thermally conducting material attached to a first face of one or both Peltier devices.

7. The apparatus of any of paragraphs 1 to 4, wherein the thermally conducting chamber comprises a removable frame of thermally conducting material configured to be placed in contact with a first face of each Peltier device during use.

8. The apparatus of any preceding paragraph, wherein the reaction vessel has a generally rectangular cross-section defined by two major walls and two minor walls, and wherein the thermally conducting chamber is configured such that each Peltier device is adjacent to a respective major wall of the reaction vessel during use.

9. The apparatus of any preceding paragraph, wherein the reaction vessel has a lid, and wherein the thermally conducting chamber is configured such that the lid of the reaction vessel is positioned between the Peltier devices during use.

10. The apparatus of any of paragraphs 1 to 8, wherein the reaction vessel has a flanged lid, and wherein the thermally conducting chamber is configured such that the flanged lid protrudes from between the Peltier devices during use.

11. The apparatus of paragraph 9 or 10, wherein the thermally conducting chamber comprises a cap portion configured to physically contact the lid of the reaction vessel during use.

12. The apparatus of paragraph 11, wherein the cap portion comprises a heating element configured to enable the lid of the reaction vessel to be heated independently of heating by the Peltier devices.

13. The apparatus of paragraph 12, wherein the cap portion comprises a temperature sensor.

14. The apparatus of paragraph 13, wherein each Peltier device has a first face and a second face, and wherein the first face and second face of each Peltier device comprises one or more respective temperature sensors.

15. The apparatus of paragraph 14, wherein the apparatus comprises a controller configured to receive measurements from the temperature sensors and control the temperature of one or more of the first Peltier device, the second Peltier device and the cap portion of the thermally conducting chamber based on the received measurements.

16. The apparatus of paragraph 15, wherein the controller is configured to apply a common temperature cycle to the Peltier devices and cap portion.

17. The apparatus of paragraph 16, wherein the controller is configured to apply a temporal offset such that the temperature cycle of the cap portion is advanced relative to the temperature cycle of the Peltier devices.

18. The apparatus of any of paragraphs 14 to 17, wherein the second face of each Peltier device comprises a heat sink having a fan, and wherein the controller is configured to control the speed of the fans based on the received measurements from the temperature sensors on the first and/or second faces of the Peltier devices.

19. The apparatus of any of paragraphs 12 to 18, wherein the cap portion comprises a non-stick coating configured to prevent adhesion of the lid of the reaction vessel to the cap portion.

20. The apparatus of any of paragraphs 11 to 19, wherein the reaction vessel has a flanged lid comprising a flange portion, and wherein the cap portion of the thermally conducting chamber comprises cutting means for removing the flange portion of the flanged lid.

21. The apparatus of any of paragraphs 11 to 20, wherein the thermally conducting chamber is configured such that the cap portion applies pressure to the lid of the reaction vessel during use.

22. The apparatus of any of paragraphs 11 to 21, wherein the thermally conducting chamber comprises a base portion, and wherein the apparatus comprises an ejection system formed in the base portion for ejecting the reaction vessel from the thermally conducting chamber after use.

23. The apparatus of paragraph 22, wherein the ejection system comprises a temperature sensor and is configured to automatically stop heating of the reaction vessel when a temperature measured by the temperature sensor exceeds a predefined threshold.

24. The apparatus of paragraph 22 or 23, wherein the ejection system comprises a biasing means configured to force the reaction vessel towards the cap portion of the thermally conducting chamber during use.

25. The apparatus of paragraph 22 or 23, wherein the cap portion is configured to be opened to enable removal of the reaction vessel from the thermally conducting chamber, and wherein the ejection system is coupled to the cap portion such that the reaction vessel is raised from the base portion as the cap portion is opened.

26. The apparatus of any preceding paragraph, wherein the apparatus comprises biasing means configured to force the Peltier devices together to facilitate the transfer of heat between the reaction vessel and the Peltier devices.

27. The apparatus of any preceding paragraph, wherein the apparatus comprises fastening means configured to hold the Peltier devices together to facilitate the transfer of heat between the reaction vessel and the Peltier devices.

28. A reaction vessel comprising a body and a lid configured to be coupled together to contain its contents therein, wherein the body and lid each comprise a weldable portion configured such that heating of the lid to a predefined temperature when coupled to the body causes fusion of the weldable portions to seal the contents within the reaction vessel.

29. The reaction vessel of paragraph 28, wherein the weldable portions comprise corresponding flange portions of the body and lid.

30. The reaction vessel of paragraph 29, wherein the lid has a generally rectangular shape comprising two major sides and two minor sides, and wherein the flange portion of the lid extends from the major sides and/or minor sides.

31. The reaction vessel of any of paragraphs 28 to 30, wherein the lid comprises a bung configured to close an opening in the body.

32. The reaction vessel of paragraph 31, wherein the weldable portion of the lid comprises a weld bead formed around a perimeter of the bung.

33. The reaction vessel of any of paragraphs 28 to 32, wherein the reaction vessel comprises fastening means configured to secure the lid to the body when the lid and body are coupled together.

34. The reaction vessel of any of paragraphs 28 to 33, wherein the lid or body comprises one or more upstands configured to guide the coupling therebetween.

35. The reaction vessel of any of paragraphs 28 to 34, wherein the body comprises a collar configured to inhibit or retard the transfer of heat from the lid to the contents of the reaction vessel during fusion of the weldable portions.

36. The reaction vessel of any of paragraphs 28 to 35, wherein the body has a generally rectangular cross-section defined by two major walls and two minor walls, and wherein the major walls and/or minor walls diverge towards the lid.

37. The reaction vessel of any of paragraphs 28 to 36, wherein the body comprises one or more window portions for optical interrogation of the contents of the reaction vessel.

1. A reaction vessel comprising a body and a lid configured to be coupled together to contain its contents therein, wherein the body and lid each comprise a weldable portion configured such that heating of the lid to a predefined temperature when coupled to the body causes fusion of the weldable portions to seal the contents within the reaction vessel.

2. The reaction vessel of claim 1, wherein the weldable portions comprise corresponding flange portions of the body and lid.

3. The reaction vessel of claim 1 or 2 wherein the body comprises a generally rectangular or rectangular cross section comprises two major sides and two minor sides, and optionally wherein the major walls and/or minor walls diverge towards the lid.

4. The reaction vessel of any of claims 1-3, wherein the lid has a generally rectangular shape comprising two major sides and two minor sides, and wherein the flange portion of the lid extends from the major sides and/or minor sides.

5. The reaction vessel of any of claims 1 to 4, wherein the lid comprises a bung configured to close an opening in the body.

6. The reaction vessel of any of claims 1-5, wherein the weldable portion of the lid comprises a weld bead formed around a perimeter of the bung.

7. The reaction vessel of any of claims 1-6, wherein the reaction vessel comprises fastening means configured to secure the lid to the body when the lid and body are coupled together.

8. The reaction vessel of any of claims 1-7, wherein the lid or body comprises one or more upstands configured to guide the coupling therebetween.

9. The reaction vessel of any of claims 1-8, wherein the body comprises a collar configured to inhibit or retard the transfer of heat from the lid to the contents of the reaction vessel during fusion of the weldable portions.

10. The reaction vessel of any of claims 1-9, wherein the body comprises one or more window portions for optical interrogation of the contents of the reaction vessel.

11. The reaction vessel according to any of claims 1-9 wherein the reaction vessel is made from a thermally conductive material, optionally
a primary material loaded with a secondary material
optionally wherein the primary material comprises one or more of polypropylene, glass, acrylic, nylon and polycarbonate, and optionally wherein the secondary material comprises one or more of carbon, graphite flakes, graphite powder, ceramic, boron nitride and diamond powder.

12. The reaction vessel of any of claims 1-11 wherein the reaction vessel is suitable for use in a polymerase chain reaction method, a molecular enzymatic process, an isothermal amplification process or an antibody mediated reaction.

13. The reaction vessel of any of claims 1-12 wherein the reaction vessel has a volume of:
a) between 20-120 ul, or between 30-110, 40-100, 50-90, 60-80 or 70 ul;
b) at least 20 ul, for example at least 30, 40, 50, 60, 70, 80, 90, 100, 110 or at least 120 ul; and/or
c) less than 120 ul, for example less than 110, 100, 90, 80, 70, 60, 50, 40, 30, 20 ul.

14. The reaction vessel of any of claims 1-13 wherein the thickness of the walls of the reaction vessel is:
a) between 0.4-1.0 mm, or between 0.5-0.9, or 0.6-0.8 mm;
b) less than 1.0 mm, less than 0.9, 0.8, 0.7, 0.6, 0.5, 0.4 mm; and/or
c) at least 0.4 mm, or at least 0.5, 0.6, 0.7, 0.8 or at least 0.9 mm; or
d) 0.6 mm.

15. The reaction vessel of any of claims 1-14 wherein the reaction vessel has a surface area to volume ratio of:
a) between 1:0.3 and 1:0.82, for example between 1:0.3 and 1:0.7; 1:0.4 and 1:0.6, or between 1:0.65 and 1:0.73; and/or
b) at least 1:0.3, for example at least 1:0.4, 1:0.5, 1:0.6. 1:0.65, 1:0.7, 1:0.73, 1:0.8, 1:0.9.

16. A reaction vessel comprising a body and a lid, suitable for use in a polymerase chain reaction method, a molecular enzymatic process, an isothermal amplification process or an antibody mediated reaction, and wherein the body comprises a generally rectangular or rectangular cross section comprises two major sides and two minor sides, and optionally wherein the major walls and/or minor walls diverge towards the lid.

17. The reaction vessel of claim 16, wherein the lid has a generally rectangular shape comprising two major sides and two minor sides, and wherein the flange portion of the lid extends from the major sides and/or minor sides.

18. The reaction vessel according to any of claim 16 or 17 wherein the reaction vessel is made from a thermally conductive material, optionally
a primary material loaded with a secondary material
optionally wherein the primary material comprises one or more of polypropylene, glass, acrylic, nylon and polycarbonate, and optionally wherein the secondary material comprises one or more of carbon, graphite flakes, graphite powder, ceramic, boron nitride and diamond powder.

19. The reaction vessel of any of claims 16-18 wherein the reaction vessel has:
A) a volume of:
a) between 20-120 ul, or between 30-110, 40-100, 50-90, 60-80 or 70 ul;
b) at least 20 ul, for example at least 30, 40, 50, 60, 70, 80, 90, 100, 110 or at least 120 ul; and/or
c) less than 120 ul, for example less than 110, 100, 90, 80, 70, 60, 50, 40, 30, 20 ul;
B) walls with a thickness of:
a) between 0.4-1.0 mm, or between 0.5-0.9, or 0.6-0.8 mm;
b) less than 1.0 mm, less than 0.9, 0.8, 0.7, 0.6, 0.5, 0.4 mm; and/or
c) at least 0.4 mm, or at least 0.5, 0.6, 0.7, 0.8 or at least 0.9 mm; or
d) 0.6 mm;
and/or
C) a surface area to volume ratio of:
a) between 1:0.3 and 1:0.82, for example between 1:0.3 and 1:0.7; 1:0.4 and 1:0.6, or between 1:0.65 and 1:0.73; and/or
b) at least 1:0.3, for example at least 1:0.4, 1:0.5, 1:0.6, 1:0.65, 1:0.7, 1:0.73, 1:0.8, 1:0.9.

20. A centrifuge configured to hold the reaction vessel according to any of the preceding claims.

21. A centrifuge configured to hold a reaction vessel with a generally rectangular or rectangular cross section, optionally configured to hold a reaction vessel with a generally rectangular or rectangular cross section comprising two major and two minor walls, wherein the major walls and/or minor walls diverge towards the lid.

22. An apparatus comprising:
a first and a second Peltier device arranged in substantial opposition to one another; and
a thermally conducting chamber defined substantially between the first and second Peltier devices and configured to enclose a reaction vessel during use to facilitate a transfer of heat between the reaction vessel and the Peltier devices.

23. The apparatus of claim 22, wherein the thermally conducting chamber is configured to physically contact all, or substantially all, of the external surface area of the reaction vessel during use.

24. The apparatus of claim 22 or 23, wherein the reaction vessel comprises one or more window portions for optical interrogation of its contents, and wherein the thermally conducting chamber is configured to physically contact substantially all of the external surface area of the reaction vessel during use except for the one or more window portions.

25. The apparatus of any of claims 22-24, wherein the thermally conducting chamber comprises two or more discrete portions configured to physically contact one another to enclose the reaction vessel.

26. The apparatus of any of claims 22-25, wherein the thermally conducting chamber is at least partially formed from a first face of one or both Peltier devices.

27. The apparatus of any of claims 22-26, wherein the thermally conducting chamber comprises a frame of thermally conducting material attached to a first face of one or both Peltier devices.

28. The apparatus of any of claims 22-27, wherein the thermally conducting chamber comprises a removable frame of thermally conducting material configured to be placed in contact with a first face of each Peltier device during use.

29. The apparatus of any of claims 22-28, wherein the reaction vessel has a generally rectangular cross-section defined by two major walls and two minor walls, and wherein the thermally conducting chamber is configured such that each Peltier device is adjacent to a respective major wall of the reaction vessel during use.

30. The apparatus of any of claims 22-29, wherein the reaction vessel has a lid, and wherein the thermally conducting chamber is configured such that the lid of the reaction vessel is positioned between the Peltier devices during use.

31. The apparatus of any of claims 22-30, wherein the reaction vessel has a flanged lid, and wherein the thermally conducting chamber is configured such that the flanged lid protrudes from between the Peltier devices during use.

32. The apparatus of any of claims 22-31, wherein the thermally conducting chamber comprises a cap portion configured to physically contact the lid of the reaction vessel during use.

33. The apparatus of claim 32, wherein the cap portion comprises a heating element configured to enable the lid of the reaction vessel to be heated independently of heating by the Peltier devices.

34. The apparatus of claim 32 or 33, wherein the cap portion comprises a temperature sensor.

35. The apparatus of any of claims 22-34 wherein each Peltier device has a first face and a second face, and wherein the first face and second face of each Peltier device comprises one or more respective temperature sensors.

36. The apparatus of any of claims 22-35, wherein the apparatus comprises a controller configured to receive measurements from the temperature sensors and control the temperature of one or more of the first Peltier device, the second Peltier device and the cap portion of the thermally conducting chamber based on the received measurements.

37. The apparatus of claim 36, wherein the controller is configured to apply a common temperature cycle to the Peltier devices and cap portion.

38. The apparatus of any of claim 36 or 37, wherein the controller is configured to apply a temporal offset such that the temperature cycle of the cap portion is advanced relative to the temperature cycle of the Peltier devices.

39. The apparatus of any of claims 22-38, wherein the second face of each Peltier device comprises a heat sink having a fan, and wherein the controller is configured to control the speed of the fans based on the received measurements from the temperature sensors on the first and/or second faces of the Peltier devices.

40. The apparatus of any of claims 22-39, wherein the thermally conducting chamber comprises a cap portion configured to physically contact the lid of the reaction vessel during use and the cap portion comprises a non-stick coating configured to prevent adhesion of the lid of the reaction vessel to the cap portion.

41. The apparatus of any of claims 22-40, wherein the reaction vessel has a flanged lid comprising a flange portion, and wherein the cap portion of the thermally conducting chamber comprises cutting means for removing the flange portion of the flanged lid.

42. The apparatus of any of claims 22-41, wherein the thermally conducting chamber is configured such that the cap portion applies pressure to the lid of the reaction vessel during use.

43. The apparatus of any of claims paragraphs 22-42, wherein the thermally conducting chamber comprises a base portion, and wherein the apparatus comprises an ejection system formed in the base portion for ejecting the reaction vessel from the thermally conducting chamber after use.

44. The apparatus of claim 43, wherein the ejection system comprises a temperature sensor and is configured to automatically stop heating of the reaction vessel when a temperature measured by the temperature sensor exceeds a predefined threshold.

45. The apparatus of claims 43 and 44, wherein the ejection system comprises a biasing means configured to force the reaction vessel towards the cap portion of the thermally conducting chamber during use.

46. The apparatus of claims 43-45, wherein the cap portion is configured to be opened to enable removal of the reaction vessel from the thermally conducting chamber, and wherein the ejection system is coupled to the cap portion such that the reaction vessel is raised from the base portion as the cap portion is opened.

47. The apparatus of any of claims 22-46, wherein the apparatus comprises biasing means configured to force the Peltier devices together to facilitate the transfer of heat between the reaction vessel and the Peltier devices.

48. The apparatus of any of claims 22-47, wherein the apparatus comprises fastening means configured to hold the Peltier devices together to facilitate the transfer of heat between the reaction vessel and the Peltier devices.

49. The apparatus of any of claims 22-48 wherein the reaction vessel is a reaction vessel according to any of claims 1-19.

50. A system comprising a reaction vessel according to any of claims 1-19 and an apparatus according to any of claims 22-49.

51. A kit comprising a reaction vessel according to any of claims 1-19 and a centrifuge according to any of claim 20 or 21.

52. A kit comprising an apparatus according to any of claims 22-49 and a reaction vessel according to any of claims 1-19.

53. A kit comprising an apparatus according to any of claims 22-49 and a centrifuge according to any of claim 20 or 21.

54. A kit comprising an apparatus according to any of claims 22-49, a centrifuge according to any of claim 20 or 21, and a reaction vessel according to any of claims 1-19.
